(19) United States
(12) Patent Application Publication
(10) Pub. No.: US 2026/0059450 A1
(43) Pub. Date: Feb. 26, 2026

(54) METHOD AND APPARATUS FOR POWER SAVING IN WI-FI COMMUNICATION

(71) Applicant: Samsung Electronics Co., Ltd., Suwon-si (KR)

(72) Inventors: Jaheon GU, Suwon-si (KR); Jonghoe KOO, Suwon-si (KR); Suhwook KIM, Suwon-si (KR); Jungjun KIM, Suwon-si (KR); Seongho BYEON, Suwon-si (KR); Mingyu LEE, Suwon-si (KR); Jinho CHOI, Suwon-si (KR); Taeyoung HA, Suwon-si (KR)

(21) Appl. No.: 19/308,908

(22) Filed: Aug. 25, 2025

(30) Foreign Application Priority Data
Aug. 26, 2024 (KR) 10-2024-0114640

(51) Int. Cl. H04W 52/02; H04W 74/08; H04W 84/12

(52) U.S. Cl. CPC H04W 52/0235; H04W 74/0866; H04W 84/12

(57) ABSTRACT

A method performed by an access point in a wireless local area network (WLAN) system is provided. The method includes receiving, from a station, a first frame on a first link in a lower capability mode (LCM) among power save modes, determining, based on the first frame, whether to switch to a higher capability mode (HCM) among the power save modes and whether to switch a link for receiving data based on the first frame, and transmitting, to the station, a response frame for the first frame on the first link, wherein in case that it is determined to switch the power save mode to the HCM and to switch the link for receiving the data to a second link, the response frame includes information indicating that the data is to be transmitted on the second link.

### CROSS-REFERENCE TO RELATED APPLICATION(S)

This application is based on and claims priority under 35 U.S.C. § 119 (a) of a Korean patent application number 10-2024-0114640, filed on Aug. 26, 2024, in the Korean Intellectual Property Office, the disclosure of which is incorporated by reference herein in its entirety.

### BACKGROUND

### 1. Field

The disclosure relates to a method for power saving in Wi-Fi communication between electronic devices.

### 2. Description of Related Art

The advancement of wireless technology has led to a significant shift from wired to wireless networks. That is, because wireless technology effectively overcomes mobility limitations inherent in wired networks, active research is underway for various technologies using wireless networks.

A Wireless Local Area Network (WLAN), also known as Wi-Fi, allows a user to access the Internet via a mobile device or laptop within a specific range around a location where an access point (AP) is installed. The Wi-Fi Alliance defines Wi-Fi as a WLAN product based on the Institute of Electrical and Electronics Engineers (IEEE) 802.11 standard. Wi-Fi communication primarily uses 2.4 gigahertz (GHz) and 5 GHz wireless bands. With the widespread adoption of portable terminals, Wireless LANs with their potential as open wireless networks are rapidly expanding. Wi-Fi is now used to provide high-speed data services in schools, airports, hotels, offices, and even entire cities.

The Internet is evolving from a human-centric network where humans generate and consume information to an Internet of Things (IoT) network where distributed components like objects exchange and process information. Internet of Everything (IoE) technology, which combines IoT with big data processing techniques through connections to cloud servers, is also emerging. Implementing IoT requires technological elements such as sensing technology, wired and wireless communication and network infrastructure, service interface technology, and security technology. Recently, technologies like sensor networks, Machine to Machine (M2M) communication, and Machine Type Communication (MTC) are being researched for connecting objects.

In an IoT environment, intelligent Internet technology (IT) services may be provided by collecting and analyzing data generated from connected objects, thereby creating new values in human life. IoT may be applied in various fields such as smart homes, smart buildings, smart cities, smart cars or connected cars, smart grids, healthcare, smart home appliances, and advanced medical services, through the convergence and combination of existing information technology (IT) technologies and diverse industries.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for performing a power saving operation in Wi-Fi communication.

Another aspect of the disclosure is to provide a method and apparatus for performing a cross-link dynamic power saving operation during Wi-Fi communication in a multi-link operation environment.

Additional aspects will be set forth in part in the description which follows and, in part, will be apparent from the description, or may be learned by practice of the presented embodiments.

In accordance with an aspect of the disclosure, a method performed by an access point in a wireless local area network (WLAN) system is provided. The method includes receiving, from a station, a first frame on a first link in a lower capability mode (LCM) among power save modes, determining, based on the first frame, whether to switch to a higher capability mode (HCM) among the power save modes and whether to switch a link for receiving data based on the first frame, and transmitting, to the station, a response frame for the first frame on the first link, wherein in case that it is determined to switch the power save mode to the HCM and to switch the link for receiving the data to a second link, the response frame includes information indicating that the data is to be transmitted on the second link.

In accordance with another aspect of the disclosure, a method performed by a station in a wireless local area network (WLAN) system is provided. The method includes transmitting, to an access point, a first frame, and receiving, from the access point, a response frame for the first frame on the first link, wherein in case that it is determined to switch a power save mode of the access point to a higher capability mode (HCM) and to switch a link for receiving data based on the first frame to a second link, the response frame includes information indicating that the data is to be transmitted on the second link.

In accordance with another aspect of the disclosure, an access point in a wireless local area network (WLAN) system is provided. The access point includes a transceiver, at least one processor communicatively coupled to the transceiver, and memory, communicatively coupled to the at least one processor, storing instructions executable by the at least one processor individually or in any combination to cause the access point to receive, from a station, a first frame on a first link in a lower capability mode (LCM) among power save modes. determine, based on the first frame, whether to switch to a higher capability mode (HCM) among the power save modes and whether to switch a link for receiving data based on the first frame, and transmit, to the station, a response frame for the first frame on the first link, and wherein in case that it is determined to switch the power save mode to the HCM and to switch the link for receiving the data to a second link, the response frame includes information indicating that the data is to be transmitted on the second link.

In accordance with another aspect of the disclosure, a station in a wireless local area network (WLAN) system is provided. The station includes a transceiver, at least one processor communicatively coupled to the transceiver, and memory, communicatively coupled to the at least one processor, storing instructions executable by the at least one processor individually or in any combination to cause the station to transmit, to an access point, a first frame, receive, from the access point, a response frame for the first frame on the first link, wherein in case that it is determined to switch a power save mode of the access point to a higher capability mode (HCM) and to switch a link for receiving data based on the first frame to a second link, the response frame includes information indicating that the data is to be transmitted on the second link.

According to an embodiment of the disclosure, an electronic device may efficiently use wireless resources and increase the lifespan of a device operating as an access point by performing a cross-link dynamic power saving operation during Wi-Fi communication in a multi-link operation environment.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a diagram illustrating a short-range communication connection configuration of an electronic device according to an embodiment of the disclosure;

FIG. 1B is a diagram illustrating an operation of establishing a Wi-Fi connection between an access point (AP) and a station (STA) according to an embodiment of the disclosure;

FIG. 2 is a diagram illustrating a wireless communication system including an AP and STAs according to an embodiment of the disclosure;

FIG. 3A is a diagram illustrating a dynamic power save (DPS)-mode operation according to an embodiment of the disclosure;

FIG. 3B is a diagram illustrating a DPS-mode operation in a multi-link operation (MLO) environment according to an embodiment of the disclosure;

FIG. 4 is a diagram illustrating duration setting in a DPS operation in an MLO environment according to an embodiment of the disclosure;

FIG. 5 is a diagram illustrating duration setting in a cross-link DPS operation in an MLO environment according to an embodiment of the disclosure;

FIG. 6 is a diagram illustrating an operation of terminating a set duration using a “contention free-end (CF-End)” frame in a cross-link DPS operation in an MLO environment by an STA according to an embodiment of the disclosure;

FIG. 7 is a diagram illustrating an operation of terminating a set duration using a “CF-End” frame in a cross-link DPS operation in an MLO environment by an AP according to an embodiment of the disclosure;

FIG. 8 is a diagram illustrating an operation of setting a new duration in a non-cross-link DPS operation in an MLO environment by an AP according to an embodiment of the disclosure;

FIG. 9 is a diagram illustrating an operation of securing a duration using a control frame in a cross-link DPS operation in an MLO environment by an AP according to an embodiment of the disclosure;

FIG. 10 is a diagram illustrating the structure of a management frame format according to an embodiment of the disclosure;

FIGS. 11A and 11B are diagrams illustrating an example of a dynamic power save mode (DPSM) switch request element format according to various embodiments of the disclosure;

FIG. 12A is a diagram illustrating an example of a DPSM switch response element format according to an embodiment of the disclosure;

FIG. 12B is a diagram illustrating subfields of Link Capabilities included in a DPSM switch response element format according to an embodiment of the disclosure;

FIG. 13 is a diagram illustrating the structure of a Multi-STA BlockAck frame format according to an embodiment of the disclosure;

FIG. 14 is a diagram illustrating an example of a DPSM switch request element format included in a Multi-STA BlockAck frame format according to an embodiment of the disclosure;

FIG. 15 is a diagram illustrating an example of a DPSM switch response element format included in a Multi-STA BlockAck frame format according to an embodiment of the disclosure;

FIG. 16 is a flowchart illustrating an operation of an AP according to an embodiment of the disclosure;

FIG. 17 is a flowchart illustrating an operation of an STA according to an embodiment of the disclosure;

FIG. 18 is a diagram illustrating a configuration of an AP according to an embodiment of the disclosure; and

FIG. 19 is a diagram illustrating a configuration of an STA according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Advantages and features of the disclosure, and a method for achieving them may become apparent from embodiments described in detail below with reference to the accompanying drawings. However, the disclosure may not be limited to the embodiments described below but may be implemented in various different forms. The embodiments of the disclosure may be provided only to complete the disclosure and to fully inform those skilled in the art of the scope of the disclosure, and the disclosure may be defined only by the scope of the claims. Throughout the specification, the same reference numerals may refer to the same components.

It may be understood that each block of processing flowchart diagrams and combinations of the flowchart diagrams may be performed by computer program instructions. These computer program instructions may be loaded onto a processor of a general-purpose computer, a special-purpose computer, or other programmable data processing equipment, so that the instructions performed through the processor of the computer or other programmable data processing equipment may create means for performing the functions described in the flowchart block(s). These computer program instructions may also be stored in a computer-usable or computer-readable memory that may direct a computer or other programmable data processing equipment to implement functions in a specific manner, so that instructions stored in the computer-usable or computer-readable memory may produce an article of manufacture including instruction means for performing the functions described in the flowchart block(s).

Computer program instructions may also be loaded onto a computer or other programmable data processing equipment, so that a series of operations may be performed on the computer or other programmable data processing equipment to create a computer-executed process, and instructions executed on the computer or other programmable data processing equipment may provide operations for executing the functions described in the flowchart block(s).

Further, each block may represent a module, segment, or portion of code that includes one or more executable instructions for executing specified logical function(s). Further, in some alternative implementations, the functions mentioned in the blocks may occur out of order. For example, two blocks shown in succession may in fact be executed substantially concurrently, or the blocks may sometimes be executed in reverse order, depending on the function involved.

The term ‘˜unit’ used in the embodiment may refer to a software or hardware component such as a field programmable gate array (FPGA) or an application specific integrated circuit (ASIC), and ‘˜unit’ may perform certain roles. However, ‘˜unit’ may not be limited to software or hardware. ‘˜unit’ may be configured to be in an addressable storage medium and may be configured to reproduce one or more processors. Thus, according to some embodiments, a ‘˜unit’ may include components such as software components, object-oriented software components, class components and task components, and processes, functions, attributes, procedures, subroutines, segments of program code, drivers, firmware, microcode, circuits, data, databases, data structures, tables, arrays, and variables. The functionality provided in components and ‘˜units’ may be combined into a smaller number of components and ‘˜units’ or may be further separated into additional components and ‘˜units’. In addition, components and ‘˜units’ may be implemented to reproduce one or more CPUs within a device or a secure multimedia card. Also, according to some embodiments, a ‘˜unit’ may include one or more processors.

The terms ‘terminal’ or ‘device’ used herein may be referred to as mobile station (MS), user equipment (UE), user terminal (UT), wireless terminal, access terminal (AT), subscriber unit (SU), subscriber station (SS), wireless device, wireless communication device, wireless transmit/receive unit (WTRU), mobile node, mobile, or other terms. Various embodiments of the terminal may include a cellular phone, a smartphone with wireless communication functions, a personal digital assistant (PDA) with wireless communication functions, a wireless modem, a portable computer with wireless communication functions, a camera device such as a digital camera with wireless communication functions, a gaming device with wireless communication functions, a music storage and playback appliance with wireless communication functions, and an Internet appliance capable of wireless Internet access and browsing, as well as a portable unit or terminal integrating combinations of such functions. Further, the terminal may include, but is not limited to, a machine to machine (M2M) terminal and a machine type communication (MTC) terminal/device. In the disclosure, a terminal may also be referred to as an electronic device or simply a device.

Various embodiments are described below only in the context of a wireless local area network (WLAN) system, for simplicity. It may be understood that various embodiments may be equally applicable to other wireless networks (e.g., cellular networks, pico networks, femto networks, and satellite networks) as well as systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH® (Bluetooth), HiperLAN (primarily used in Europe, a set of wireless standards comparable to the IEEE 802.11 standards), and other technologies with relatively short wireless propagation ranges. Thus, the terms “WLAN” and “Wi-Fi” may be used interchangeably. Additionally, while an infrastructure WLAN system including one or more access points (APs) and multiple wireless stations (STAs) is described below, various embodiments may be equally applicable to other WLAN systems including, for example, multiple WLANs, peer-to-peer or independent basic service set systems, Wi-Fi Direct systems, and/or hotspots.

Additionally, while exchange of data frames between wireless devices is described herein, various embodiments may be applied to exchange of any data units, packets, and/or frames between wireless devices. Thus, the term “frame” may include any frame, packet, or data unit such as protocol data units (PDUs), media access control (MAC) protocol data units (MPDUs), and physical layer convergence procedure (PLCP) protocol data units (PPDUs). The term “A-MPDU” may refer to aggregated MPDUs.

In the following description, many specific details may be presented, such as examples of particular components, circuits, and processes, to provide a thorough understanding of the disclosure. The term “connected” as used herein may mean being directly connected or being connected through one or more intervening components or circuits. The term “connected access point” may mean an AP with which a given STA is currently associated and/or connected (e.g., there is a communication channel or link established between the AP and the given STA). Further, in the following description and for purposes of description, specific terminology may be set forth to provide a thorough understanding of various embodiments. However, it may be apparent to those skilled in the art that these specific details may not be required to practice the various embodiments. In other instances, well-known circuits and devices may be shown in block diagram form to avoid obscuring the disclosure.

Specific terms used in the following description may be provided to aid understanding of the disclosure, and the use of such specific terms may be changed to other forms without departing from the technical spirit of the disclosure.

Hereinafter, the operating principles of the disclosure are described in detail with reference to the accompanying drawings. In the following description of the disclosure, a detailed description of related known functions or configurations will be avoided, least it should obscure the subject matter of the disclosure. The terms described below may be terms defined in consideration of the functions in the disclosure, which may vary depending on a user's or operator's intention or custom. Therefore, their definitions should be based on the entire content of this specification.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

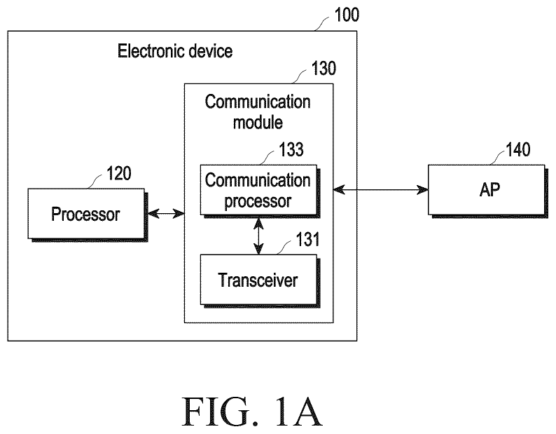

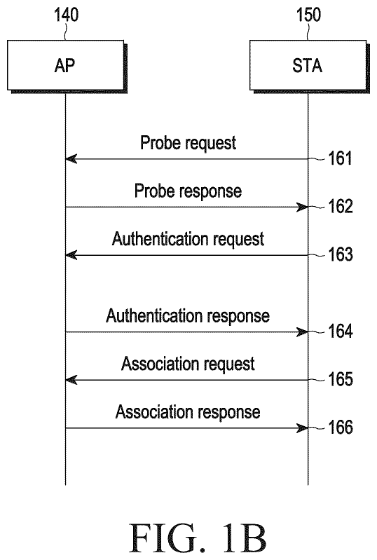

FIG. 1A is a diagram illustrating a short-range communication connection configuration of an electronic device applicable according to an embodiment of the disclosure.

Referring to FIG. 1A, an electronic device 100 may be connected to an AP 140 based on a plurality of Wi-Fi-based communication schemes. According to various embodiments, the electronic device 100 may include a processor 120 and a communication module 130.

According to various embodiments, the communication module 130 may receive a communication signal from the outside or transmit a communication signal to the outside based on a Wi-Fi communication scheme (e.g., IEEE 802.11be). For example, the communication module 130 may operate based on IEEE 802.11ac, 802.11ax, 802.11be, or 802.11bn among Wi-Fi communication schemes, and specifically, IEEE 802.11be or 802.11bn may have improved performance by supporting a wider bandwidth (BW), higher data throughput, and shorter latency compared to IEEE 802.11ax.

According to various embodiments, the communication module 130 may include a transceiver 131 for transmitting and receiving data with an external device and a communication processor 133 or a short-range wireless communication module (e.g., a Wi-Fi chipset)). According to various embodiments, the communication module 130 may further include memory.

According to various embodiments, the transceiver 131 may convert a baseband transmission signal into a radio signal, or convert a received radio signal into a baseband reception signal.

Although not shown, according to various embodiments, the electronic device 100 may further include components for orthogonal frequency division multiplexing (OFDM) or orthogonal frequency division multiple access (OFDMA), such as a modulator, a digital-analog (D/A) converter, a frequency converter, an A/D converter, an amplifier, and/or a demodulator, in addition to the transceiver 131 and the communication processor 133.

Although not shown, according to various embodiments, the electronic device 100 may be electrically connected to a communication module of the AP 140 and include at least one antenna module that supports a communication protocol and/or frequency band supported by the communication module of the AP 140.

According to various embodiments, the communication processor 133 may control the transceiver 131 to establish a communication connection with the AP 140. For example, the communication connection may include a Wi-Fi network. For example, the communication processor 133 may control the transceiver 131 to establish a wireless connection with the AP 140 using a WLAN standard in the 2.4 GHz, 5 GHZ, or 6 GHz band, such as IEEE 802.11ac, 802.11ax, 802.11be, or 802.11bn. Alternatively, the communication processor 133 may control the transceiver 131 to establish a wireless connection with the AP 140 using a WLAN standard in the 60 GHz band, such as IEEE 802.11ad or 802.11ay.

According to various embodiments, a communication scheme based on a WLAN standard between the electronic device 100 and the AP 140 may be referred to as an STA mode-based communication scheme.

According to various embodiments, the processor 120 may include an application processor. The processor 120 may perform a specified operation of the electronic device 100 or control other hardware (e.g., the communication module 130) to perform the specified operation.

According to various embodiments, the AP 140 may support an operation of transmitting data to an external network (e.g., the Internet, an external LAN, or a cellular network) and/or an operation of receiving data from the external network at a plurality of electronic devices (e.g., the electronic device 100), based on connections between the plurality of electronic devices (e.g., the electronic device 100) and the external network.

According to various embodiments, the AP 140 may be a wireless router. The AP 140 may be a specified wireless router, or a general-purpose device that supports mobile hotspot functionality, and its implementation is not limited. For example, the AP 140 may include the same components (e.g., a processor and/or a communication module) as the electronic device 100.

According to various embodiments, the AP 140 may transmit and receive data to and from an external device such as a server (e.g., a server 108 of FIG. 1A) or the electronic device 100. For example, the AP 140 may transmit at least a portion of data received from the server to the electronic device 100. According to various embodiments, the AP 140 and the electronic device 100 may transmit and receive uplink (UL)/downlink (DL) data during an operation period. For example, the AP 140 may transmit traffic to the electronic device 100 only during an operation period set based on schedule information received from the electronic device 100.

FIG. 1B is a diagram illustrating operations of an AP and an STA to establish a Wi-Fi connection according to an embodiment of the disclosure.

Referring to FIG. 1B, the AP 140 may communicate with an STA 150 based on Wi-Fi. The STA 150 may be implemented as the electronic device 100 in FIG. 1A. The STA 150 may be a terminal (or a terminal with a Wi-Fi interface) that supports Wi-Fi communication according to the IEEE 802.11 standard.

The STA 150 may transmit (or broadcast) a probe request message to the AP 140 operation 161. According to an embodiment, the probe request message may be a message used for the STA 150 to discover the adjacent AP 140. According to an embodiment, the probe request message may include information about at least one communication capability supported by the STA 150. According to an embodiment, the STA 150 may receive a beacon message from the AP 140 and transmit the probe request message to the AP 140 based on information included in the beacon message. The AP 140 may transmit a probe response message in response to the probe request message operation 162.

Upon receipt of the probe response message, the STA 150 may transmit an authentication request message to the AP 140 (S163). The AP 140 may transmit an authentication response message to the STA 150 in response to the authentication request message operation 164, and an authentication procedure between the AP 140 and the STA 150 may be completed. According to an embodiment, the authentication procedure in operations 163 and 164 may be a process of selecting and authenticating a channel with a largest received signal strength among messages received during a channel discovery process. According to an embodiment, the STA 150 and the AP 140 may negotiate an encryption scheme of the authentication procedure through the authentication procedure in operations 163 and 164.

Once the authentication procedure is completed, the STA 150 may transmit an association request message to the AP 140 to perform connection setup with the AP 140 operation 165. According to an embodiment, the association request message may include information about at least one capability (e.g., according to the IEEE 802.11 standard) to be used for data communication between the STA 150 and the AP 140. The AP 140 may generate an association ID (AID) for the STA 150 and transmit an association response message to the STA 150 operation 166.

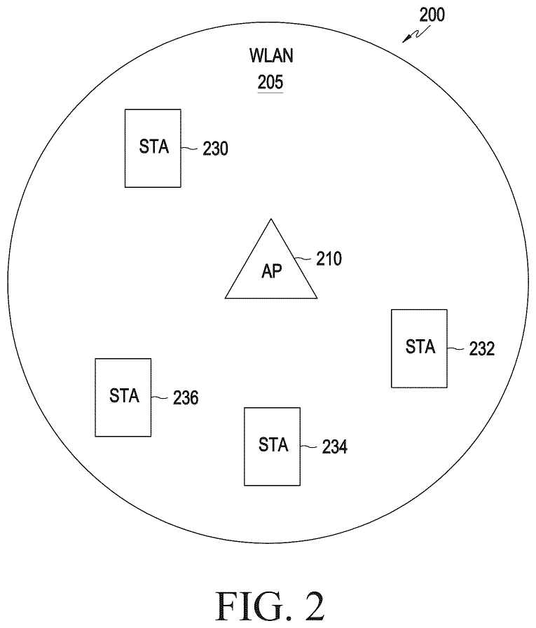

FIG. 2 illustrates a wireless communication system including an AP and STAs, which is applicable according to an embodiment of the disclosure.

Referring to FIG. 2, a wireless communication system 200 may include an AP 210, client electronic devices (i.e., STAs 230, 232, 234, and 236) corresponding to STAs, and a WLAN 205.

The wireless communication system 200 may be formed by the AP 210 that provides wireless communication channels or links to one or more STAs 230, 232, 234, and 236.

The AP 210 may be assigned a unique medium access control (MAC) address. The WLAN 205 shown as a circular shape in FIG. 2 may be illustrated as an infrastructure basic service set (BSS), which is a basic component block in an IEEE 802.11 system. However, in other various embodiments, the WLAN 205 may be an independent basic service set (IBSS) network or a peer-to-peer (P2P) network (e.g., operating according to Wi-Fi Direct protocols). The circular shape of the WLAN 205 shown in FIG. 2 may also be understood to represent a coverage area where STAs included in the BSS maintain communication. This area may be referred to as a basic service area (BSA). When the STAs 230, 232, 234, and 236 move out of the BSA, they may not be able to communicate directly with the AP or other STAs within the BSA. The AP 210 may be a dedicated wireless router, or an STA that supports mobile hotspot functionality, and in this case, the AP 210 may be referred to as an AP STA.

The STAs 230, 232, 234, and 236 are devices that operate according to the IEEE 802.11 MAC/PHY specifications. Unless the function of an STA is separately distinguished from that of an AP, the STA may include an AP STA and a non-AP STA. However, when communication is performed between an STA and an AP, the STA may be understood as a non-AP STA. When an STA supports mobile hotspot functionality and operates like the AP 210, the STA may be understood as an AP STA.

The STAs 230, 232, 234, and 236 may be any suitable Wi-Fi-enabled wireless devices or electronic devices, including, for example, cell phones, PDAs, tablet devices, and laptop computers. The STAs 230, 232, 234, and 236 may also be referred to as UEs, subscriber stations, mobile units, subscriber units, wireless units, remote units, mobile devices, wireless devices, wireless communication devices, remote devices, mobile subscriber stations, access terminals, mobile terminals, wireless terminals, remote terminals, handsets, user agents, mobile clients, clients, electronic devices, or any other suitable technical term.

### Multi-Link Operation (MLO)

An MLO refers to the ability to simultaneously transmit and receive data over different frequency bands and channels. An STA and an AP may operate multiple Wi-Fi interfaces across several bands (e.g., 2.4 GHz, 5 GHZ, and 6 GHZ) together to increase network throughput. A multi-link device (MLD) may refer to a device capable of performing an MLO, that is, an AP or STA capable of performing an MLO in a WLAN system. An AP and an STA as MLDs may be referred to as an “AP MLD” and a “non-AP MLD”, respectively.

In an MLO, a multi-channel operation (MCO) and a multi-band operation (MBO) may be supported.

An MCO may refer to a method of separately allocating transmission and reception channels within the same frequency band through multiple input multiple output (MIMO). An MBO is a method of separately allocating transmission and reception channels through MIMO by using various frequency bands. In this method, different bands are allocated to the transmission channel and the reception channel.

Each frequency band that may operate in an MLO may be referred to as a link, and specific operations of the MLO may include multi-link multi-radio (MLMR) and multi-link single-radio (MLSR) depending on the design specifications and implementation of a terminal.

“MLMR” refers to fixed allocation of multiple links. For example, an MLMR-supporting terminal may simultaneously use at least two of the 2.4 GHz, 5 GHZ, and 6 GHz bands.

“MLSR” refers to a mode that may operate on multiple links but use only one link at a time, allowing the link to be switched to another link as an operating band when needed. For example, an MLSR-supporting terminal may operate at 2.4 GHz and then switch the link to 5 GHz. When operating at 2.4 GHZ, the terminal may not be monitoring the channel state of the 5 GHz link, and thus it may take time for channel synchronization, when the terminal switches to 5 GHZ.

### Power Save (PS) Mode

A WLAN system may operate an active mode and a PS mode, so that an AP and an STA reduce power consumption during a required channel sensing operation before performing transmission and reception.

In the active mode, the AP and the STA maintain an awake state in which a normal operation such as frame transmission/reception or channel scanning is possible. In the PS mode, the AP and the STA may switch between a sleep state (or doze state) and the awake state. When operating in the sleep state, the AP or the STA maintains an association state with the STA or the AP but with minimum power, and does not perform frame transmission/reception or channel scanning. The PS mode may be operated as a scheduled AP PS mode, which may be implemented as an AP operation with target wake time (TWT)-based ON-OFF duty cycling.

A dynamic power save (DPS) mode may enable a light sleep operation, meaning that a listen state (LS) may also be operated in addition to the awake state and the sleep state (or doze state) distinguished in the PS mode. The LS may allow the AP to perform a limited operation (e.g., turn off a high BW/number of spatial streams (NSS) transmission/reception function). Further, the LS may enable only a minimum reception function (e.g., receiving only a non-HT PPDU). Further, in the LS, the AP may operate based on dynamic spatial multiplexing (SM) PS/enhanced multi-link single radio (eMLSR).

In addition, in the DPS mode, the AP may operate by setting a lower capability mode (LCM) and a higher capability mode (HCM).

The “LCM” may refer to a mode where the AP uses a lower capacity (capability) than in the “HCM”, and the “HCM” may refer to a mode where the AP uses a higher capacity (capability) than in the LCM. Parameters for a specific operation may be configured differently depending on a design and implementation. For example, the LCM and the HCM may be predefined for at least one of a BW or a spatial stream for a transmission/reception operation. For example, the LCM may refer to a mode with a BW of 20 MHz and an NSS of 1, and the HCM may refer to a mode with a BW of 160 MHz and an NSS of 2. However, the LCM and the HCM may be defined differently depending on a link on which the terminal operates, not limited thereto. For example, the LCM may include operating in an LS mode.

In the present disclosure, the terms “low capacity mode” and “high capacity mode” are used interchangeably with “lower capability mode” and “higher capability mode.” Accordingly, when a specific component is described as either “low capacity mode/high capacity mode” or “lower capability mode/higher capability mode” in the present specification, such terms are to be technically interpreted as interchangeable with one another.

### PS Mode of AP

In an IEEE 802.11 system, the PS mode defines an awake state where data transmission/reception is possible and a sleep state (or doze state) where power to a WLAN interface is cut off, to reduce power consumption of an STA. On the other hand, when the PS mode is not operated for an AP, the AP may always maintain the awake state, consuming much power. In particular, even in the case of a mobile AP which is a wireless terminal used as an AP, this phenomenon may equally apply, directly impacting a battery life in an environment such as tethering, thus increasing the necessity for operating the PS mode for an AP.

Table 1 below illustrates an example of PS modes that may be operated in an AP.

TABLE 1

| AP PS | | Inactive | Active | Inactive/Active | PS | KPI¹ |
|---|---|---|---|---|---|---|
| modes | Status | Periods | Periods | Duration | benefits | impact |
| BW/NSS- | Baseline | None | All | None/All | Medium | Medium |
| based | | | | | | |
| Link | Baseline | In | In | ~Seconds or | High² | Higher |
| Disablement | | Disabled | Enabled | more | | |
| | | Links | Links | (order of | | |
| | | | (At | DTIM | | |
| | | | least | interval) | | |
| | | | one | | | |
| | | | link) | | | |
| Scheduled | UHR | Outside | Within | ~Tens of ms. | Medium ³ | Medium ³ |
| AP PS | Candidate | Wake | Wake | or more | | |
| | | SPs | SPs | | | |
| Dynamic | UHR | None | All | None/All | Medium | Minimal |
| AP PS | Candidate | | | | | |

¹Key performance indicator (KPI) refers to one of throughput, latency or reliability.
²AP power save is the highest on the disabled links, with no power save on the enabled link.
³There is a trade-off between AP PS and KPI impact which depends on the on-off duty cycle.

A BW/NSS-based mode may refer to a mode where the AP is restricted from operating in a specific BW and NSS without inactive periods. A link disablement mode may refer to an operation of disabling the remaining links except for a specific intended link by an MLO-enabled AP.

A scheduled AP PS mode refers to a mode where the AP operates in the PS mode, that is, in the awake state and the sleep state. A dynamic AP PS mode refers to a dynamic PS mode of the AP, as described before.

### Duration Setting

The AP or the STA may set a duration, which may be a time interval during which it has the right to use a channel during a frame exchange sequence on the channel. During the duration, it may have the right to restrict transmissions from APs or STAs other than the AP or STA participating in the frame exchange sequence. The AP or STA that has set the duration may be referred to as a holder, and the other party may be referred to as a responder. Generally, a duration may be obtained through contention, and a typical procedure for initiating a duration is transmission of an initial control frame (ICF).

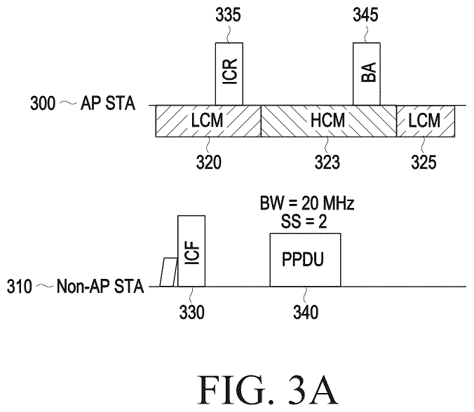

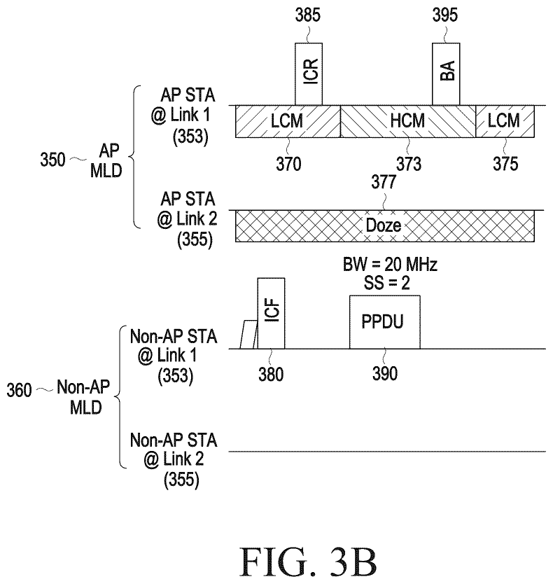

FIG. 3A is a diagram illustrating a DPS-mode operation according to an embodiment of the disclosure.

An AP STA 300 and a non-AP STA 310 illustrated in FIG. 3A may be connected and communicate with each other, similar to the AP 140, the electronic device 100, and the STA 150 described in FIGS. 1A and 1B. The non-AP STA 310 illustrated in FIG. 3A may be an STA included in the BSS of the AP STA 300 as described with reference to FIG. 2.

Referring to FIG. 3A, when operating in the DPS mode, the AP STA 300 may operate in the doze state and the active state, and in the active state, it may operate by setting LCMs 320 and 325 and an HCM 323.

Referring to FIG. 3A, when the non-AP STA 310 intends to transmit or receive, it may participate in contention and transmit an ICF 330. In the LCM 320 of the DPS mode, the AP STA 300 may receive the ICF 330 and transmit an initial control response frame (ICR) 335 in response to the ICF 330.

The ICF may refer to a frame that an ICF-transmitting device (AP STA or non-AP STA) transmits to initiate a duration for using a corresponding link, or activate a link of another device (e.g., transition another device to the awake state). In particular, the ICF may be used between MLDs performing an MLO, and may be implemented as, but is not limited to, a control frame (e.g., a trigger frame or a BlockAck frame) or a management frame.

The AP STA 300 may dynamically determine whether to switch the PS mode based on the received ICF 330. In an embodiment, when the AP STA 300 determines to switch the PS mode based on the ICF 330, it may switch the mode from the LCM 320 to the HCM 323 after transmitting the ICR 335. In an embodiment, when the AP STA 300 determines to switch the PS mode based on the ICF 330, it may switch the mode from the LCM 320 to the HCM 323 after receiving the ICF 330. In an embodiment, when the AP STA 300 determines to switch the PS mode based on the ICF 330, the ICR 335 may include information indicating switching of the PS mode.

The non-AP STA 310 may then transmit a PPDU 340. In an embodiment, the non-AP STA 310 may transmit the PPDU 340 based on the HCM. For example, the non-AP STA 310 may transmit the PPDU 340 with BW=20 MHz and SS=2. The AP STA 300 may receive the PPDU 340 in the HCM 323, and transmit a block Ack (BA) frame 345 in response to the PPDU 340. Subsequently, the AP STA 300 may switch the PS mode to the LCM 325.

FIG. 3B is a diagram illustrating a DPS-mode operation in an MLO environment according to an embodiment of the disclosure.

An AP MLD 350 and a non-AP MLD 360 illustrated in FIG. 3B may be connected and communicate with each other, similar to the AP 140, the electronic device 100, and the STA 150 described in FIGS. 1A and 1B. The non-AP MLD 360 illustrated in FIG. 3B may be an STA included in the BSS of the AP MLD 350 as described with reference to FIG. 2.

The AP MLD 350 and the non-AP MLD 360 illustrated in FIG. 3B, which are MLDs, that is, devices capable of performing an MLO, may operate in different bands, namely a first link (Link 1) 353 and a second link (Link 2) 355. For example, Link 1 353 and Link 2 355 may include, but are not limited to, 2.4 GHz and 5 GHZ, respectively.

Referring to FIG. 3B, when operating in the DPS mode, the AP MLD 350 may operate in a doze state 377 and an active state, and in the active state, it may operate by setting LCMs 370 and 375 and an HCM 373. The LCMs 370 and 375 may refer to a mode using a lower capacity (capability) than the HCM 373, as described before, and include an LS-mode operation. For example, the LCM and the HCM may be predefined for at least one of a BW or a spatial stream for a transmission/reception operation.

Referring to FIG. 3B, when the non-AP MLD 360 intends to transmit or receive, it may participate in contention and transmit an ICF 380 on Link 1 353. In the LCM 370 of the DPS mode, the AP MLD 350 may receive the ICF 380 on Link 1 353 and transmit an ICR 385 on Link 1 353 in response to the ICF 380.

The AP MLD 350 may dynamically determine whether to switch the PS mode based on the received ICF 380. In an embodiment, when the AP MLD 350 determines to switch the PS mode based on the ICF 380, it may switch the mode from the LCM 370 to the HCM 373 after transmitting the ICR 385. In an embodiment, when the AP MLD 350 determines to switch the PS mode based on the ICF 380, it may switch the mode from the LCM 370 to the HCM 373 after receiving the ICF 380.

Thereafter, the Non-AP MLD 360 may transmit a PPDU 390 on Link 1 353. In an embodiment, the non-AP MLD 360 may transmit the PPDU 390 based on the HCM. For example, the non-AP MLD 360 may transmit the PPDU 390 with BW=20 MHz and SS=2. In the HCM 373, the AP MLD 350 may receive the PPDU 390 on Link 1 353 and transmit a BA frame 395 on Link 1 353 in response to the PPDU 390. Subsequently, the AP MLD 350 may switch to the LCM 375.

In FIG. 3B, even if the AP MLD 350 and the non-AP MLD 360 perform an MLO, Link 2 355 may not be used, and the AP MLD 350 may maintain the doze state 377 on Link 2 355. Accordingly, the disclosure proposes a method for operating the DPS mode on a cross link for efficient resource utilization.

In addition to the aspect of idle resource utilization described above, the usefulness of a cross-link operation in the DPS mode in terms of bit rate will be described below.

Comparison between Bands in terms of Power Consumption and Bit Rate of Mobile Device

An example of current consumptions measured during reception in a BW of 20 MHz, for a single spatial stream (1×1) and a dual spatial stream (2×2) in the idle state of the mobile device is given in Table 2 below.

TABLE 2

| Spatial streams | 2.4 GHz | 5 GHz |
|---|---|---|
| 1 × 1 | 24.1 mA | 35.6 mA |
| 2 × 2 | 27.7 mA | 40.4 mA |

Depending on its design capacity, the terminal may operate, at 5 GHz, with a BW of 80 MHz and a higher modulation and coding scheme (MCS) than at 2 GHz. An example comparing current consumption values measured during reception in a BW of 20 MHz at 2.4 GHz and in a BW of 80 MHz at 5 GHz in the active state of the mobile device is given in Table 3 below.

TABLE 3

| | 2.4 GHz/20 MHz HE | 5 GHz/80 MHz HE |
|---|---|---|
| Spatial streams | MCS9 | MCS11 |
| 1 × 1 | 31.9 mA | 66.3 mA |
| 2 × 2 | 43.4 mA | 95.9 mA |

From a comparison between Table 2 and Table 3, it may be identified that in the same voltage environment, the average power consumption is higher in the 5 GHZ band than in the 2.4 GHz band under all conditions. Further, Table 3 reveals that for a dual stream (2×2) in the same voltage environment, the average received power consumption proportional to current in the 5 GHz band/80 MHz BW is approximately twice that of the 2.4 GHz band/20 MHz BW.

In a comparison between bit rates, for the dual stream (2×2), the measured bit rate in the 2.4 GHz band with a BW of 20 MHz is 173 Mbps, while it is 1083 Mbps in the 5 GHz band with a BW of 80 MHz, meaning that the former has an increase of approximately 6 times. Thus, it may be identified that even with an increase in power consumption, the bit rate may be significantly increased, indicating a gain outweighs the loss. Considering this, the disclosure proposes a method for dynamically saving power while improving communication performance by switching links as needed.

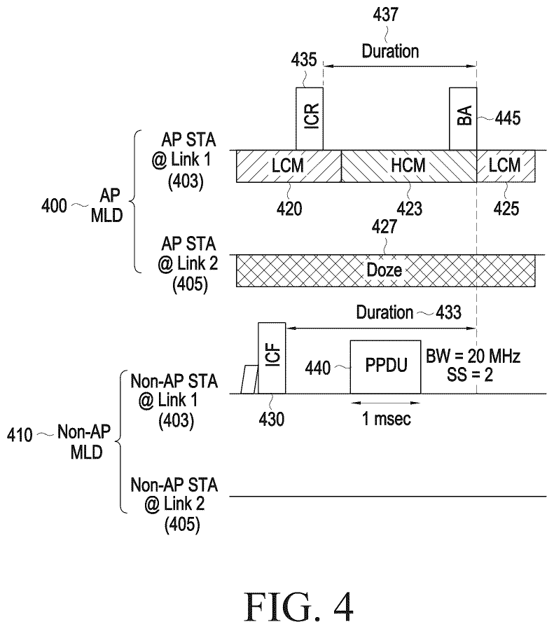

FIG. 4 illustrates duration setting in a DPS operation in an MLO environment according to an embodiment of the disclosure.

Referring to FIG. 4, an AP MLD 400 and a non-AP MLD 410 may be connected and communicate with each other, similar to the AP 140, the electronic device 100, and the STA 150 described in FIGS. 1A and 1B. The non-AP MLD 410 illustrated in FIG. 4 may be an STA included in the BSS of the AP MLD 410 as described with reference to FIG. 2.

The AP MLD 400 and the non-AP MLD 410 illustrated in FIG. 4, which are MLDs, that is, devices capable of performing an MLO, may operate in different bands, namely Link 1 403 and Link 2 405. In an embodiment, Link 2 405 may be a higher band than Link1 403, and use a wider BW than Link 1 403. For example, Link 1 403 and Link 2 405 may include, but are not limited to, 2.4 GHz and 5 GHZ, respectively.

Referring to FIG. 4, when operation in the DPS mode, the AP MLD 400 may operate in a doze state 427 and an active state. Further, in the active state, it may operate by setting LCMs 420 and 425 and an HCM 423.

Referring to FIG. 4, when the non-AP MLD 410 intends to transmit or receive, it may participate in contention and transmit an ICF 430 on Link 1 403. When the non-AP MLD 410 participates in contention and transmits the ICF 430, it may set a duration 433 on Link 1 403.

In an embodiment, the duration 433 may be determined in consideration of a time when the non-AP MLD 410 will transmit data or a time when the non-AP MLD 410 will receive an Ack frame after the data transmission.

The AP MLD 400 may operate in the LCM 420 on Link 1 403 and in the doze state 427 on Link 2 405. In the LCM 420 of the DPS mode, the AP MLD 400 may receive the ICF 430 on Link 1 403 and transmit an ICR 435 on Link 1 403 in response to the ICF 430. When transmitting the ICR 435, the AP MLD 400 may set a duration 437 on Link 1 403, for receiving data corresponding to the ICF 430 transmitted by the terminal. In an embodiment, the duration 433 may be determined in consideration of a time when the AP MLD 400 will receive the data or a time when the AP MLD 400 will transmit the Ack frame after the data transmission.

The AP MLD 400 may determine whether to dynamically switch the PS mode based on the received ICF 430. In an embodiment, when the AP MLD 400 determines to switch the PS mode based on the ICF 430, it may switch from the LCM 420 to the HCM 423 after transmitting the ICR 435. In an embodiment, when the AP MLD 400 determines to switch the PS mode based on the ICF 430, it may switch from the LCM 420 to the HCM 423 after receiving the ICF 430.

Thereafter, the non-AP MLD 410 may transmit a PPDU 440. In an embodiment, the non-AP MLD 410 may transmit the PPDU 440 on Link 1 403 based on an HCM with BW=20 MHz and SS=2. For example, the non-AP MLD 410 may transmit the PPDU 440 on Link 1 403 with BW=20 MHz and SS=2. In an embodiment, it may take 1 msec to transmit the PPDU 440. In the HCM 423, the AP MLD 400 may receive the PPDU 440 on Link 1 403 and transmit a BA frame 445 on Link 1 403 in response to the PPDU 440. Subsequently, the AP MLD 400 may switch to the LCM 425.

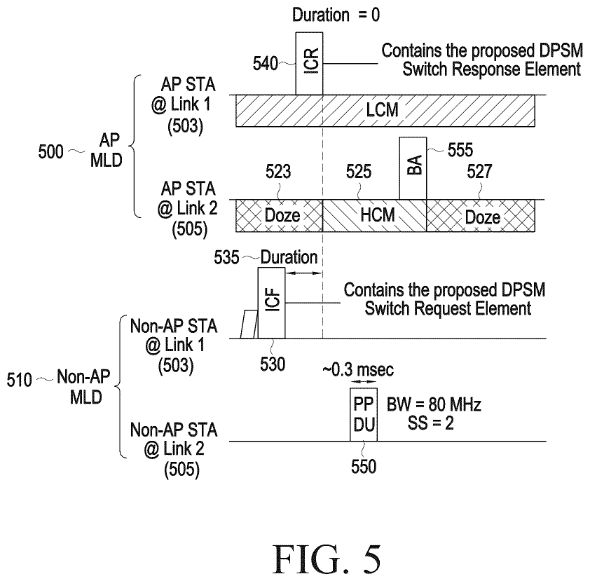

FIG. 5 illustrates duration setting in a cross-link DPS operation in an MLO environment according to an embodiment of the disclosure.

Referring to FIG. 5, an AP MLD 500 and a non-AP MLD 510 may be connected and communicate with each other, similar to the AP 140, the electronic device 100, and the STA 150 described in FIGS. 1A and 1B. The non-AP MLD 510 illustrated in FIG. 5 may be an STA included in the BSS of the AP MLD 510 as described with reference to FIG. 2.

The AP MLD 500 and the non-AP MLD 510 illustrated in FIG. 5, which are MLDs, that is, devices capable of performing an MLO, may operate in different bands, namely Link 1 503 and Link 2 505. In an embodiment, Link 2 505 may be a higher band than Link 1 503 and use a channel with a wider BW than Link 1 503. For example, Link 1 503 and Link 2 505 may include, but are not limited to, 2.4 GHz and 5 GHz, respectively.

Referring to FIG. 5, when operating in the DPS mode, the AP MLD 500 operates in doze states 523 and 527 and an active state. In the active state, it may operate by setting an LCM 520 and an HCM 525.

Referring to FIG. 5, when the non-AP MLD 510 intends to transmit or receive, it may participate in contention and transmit an ICF 530 on Link 1 503. When the non-AP MLD 510 transmits the ICF 530, it may initiate a frame exchange sequence and set a duration 535 on Link 1 503, which is a time interval during which it has the right to restrict transmissions from other APs or STAs. In an embodiment, the non-AP MLD 510 may set the duration 535 on Link 1 503 in consideration of a time when it will receive an ICR transmitted in response to the ICF 530. In an embodiment, the duration 535 set on Link 1 503 may be shorter than a time from transmission of data in the frame exchange sequence initiated by the ICF 530 until reception of an Ack frame for the data.

In an embodiment, the ICF 530 may include a dynamic power save mode (DPSM) switch request element. The DPSM switch request element may include information about non-AP request information required for performing a cross-link DPSM operation.

The AP MLD 500 may operate in the LCM 520 on Link 1 503 and in the doze state 523 on Link 2 505. In the LCM 520, the AP MLD 500 may receive the ICF 530 on Link 1 503 and transmit an ICR 540 on Link 1 503 in response to the ICF 530. The AP MLD 500 may determine whether to dynamically switch the PS mode and the link based on the received ICF 530.

In an embodiment, when the AP MLD 500 determines to switch the PS mode and the link based on the ICF 530, the AP MLD 500 may not secure a duration on Link 1 503, for receiving data corresponding to the ICF 530 transmitted by the terminal, when transmitting the ICR 540. In another embodiment, when the AP MLD 500 determines to switch the PS mode and the link based on the ICF 530, the AP MLD 500 may set a duration for receiving the data corresponding to the ICF 530 transmitted by the terminal to ‘O’ on Link 1 503, when transmitting the ICR 540.

In an embodiment, the ICR 540 may include a DPSM switch response element. In an embodiment, the DPSM switch response element may include response information of the AP MLD 500 to the DPSM switch request element.

In an embodiment, when the AP MLD 500 determines to switch the PS mode and the link based on the ICF 530, it may switch from the doze state 523 to the HCM 525 on Link 2 505 after transmitting the ICR 540. In another embodiment, when the AP MLD 500 determines to switch the PS mode based on the ICF 530, it may switch from the doze state 523 to the HCM 525 on Link 2 505 after receiving the ICF 530.

Thereafter, the non-AP MLD 510 may transmit a PPDU 550 on Link 2 505 based on the ICR 540. In an embodiment, the non-AP MLD 510 may transmit the PPDU 550 on Link 2 505 in response to the HCM. For example, the non-AP MLD 510 may transmit the PPDU 550 with BW=80 MHz and SS=2 on Link 2 505. A bit rate when transmitting the PPDU 550 with BW=80 MHz and SS=2 may be higher than a bit rate when transmitting the PPDU 440 with BW=20 MHz and SS=2 in FIG. 4. Accordingly, transmitting the PPDU 550 may take less time (˜0.3 msec) than the time (e.g., 1 msec) taken to transmit the PPDU 440 in FIG. 4.

In the HCM 525, the AP MLD 500 may receive the PPDU 550 on Link 2 505 and transmit a BA frame 555 on Link 2 505 in response to the PPDU 550. Thereafter, the AP MLD 500 may switch to the doze state 527 on Link 2 505.

In an embodiment, when the AP MLD 500 determines not to switch the link based on the ICF 530, it may set a duration on Link 1 503, for receiving the data corresponding to the ICF 530 transmitted by the terminal on Link 1 503, when transmitting the ICR 540, as illustrated in FIG. 4. In an embodiment, the duration may be determined in consideration of a time when the AP MLD 500 will receive the data or a time when it will transmit the Ack frame after the data transmission.

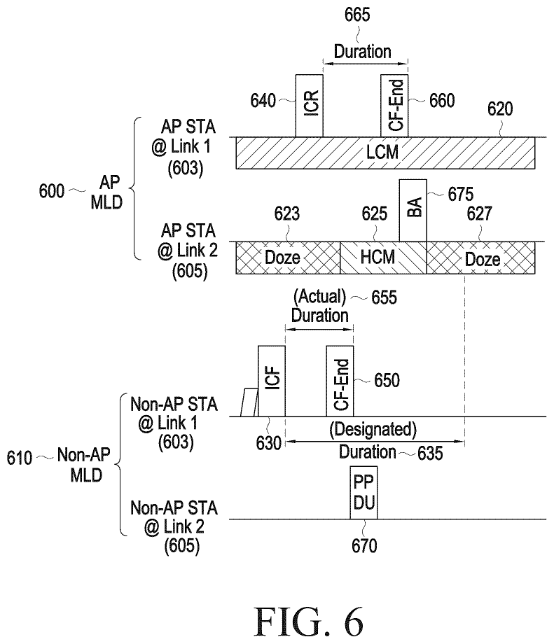

FIG. 6 illustrates an operation of terminating a set duration using a “contention free-end (CF-End)” frame in a cross-link DPS operation by an STA in an MLO environment according to an embodiment of the disclosure.

An AP MLD 600 and a non-AP MLD 610 illustrated in FIG. 6 may be connected and communicate with each other, similar to the AP 140, the electronic device 100, and the STA 150 described in FIGS. 1A and 1B. The non-AP MLD 610 illustrated in FIG. 6 may be an STA included in the BSS of the AP MLD 610 as described with reference to FIG. 2.

The AP MLD 600 and the non-AP MLD 610 illustrated in FIG. 6, which are MLDs, that is, devices capable of performing an MLO, may operate in different bands, namely Link 1 603 and Link 2 605. In an embodiment, Link 2 605 may be a higher band than Link 1 603 and use a channel with a wider BW than Link 1 603. For example, Link 1 603 and Link 2 605 may include, but are not limited to, 2.4 GHz and 5 GHz, respectively.

Referring to FIG. 6, when operating in the DPS mode, the AP MLD 600 operates in doze states 623 and 627 and an active state. In the active state, it may operate by setting an LCM 620 and an HCM 625.

Referring to FIG. 6, when the non-AP MLD 610 intends to transmit or receive, it may participate in contention and transmit an ICF 630 on Link 1 603. When the non-AP MLD 610 transmits the ICF 630, it may initiate a frame exchange sequence and set a duration 635 on Link 1 603, which is a time interval during which it has the right to restrict transmissions from other APs or STAs. In an embodiment, the duration 635 may be determined in consideration of a time when the non-AP MLD 610 will transmit data or a time when the non-AP MLD 610 will receive an Ack frame after the data transmission. In an embodiment, the ICF 630 may include a DPSM switch request element.

The AP MLD 600 may operate in the LCM 620 on Link 1 603 and in the doze state 623 on Link 2 605. In the LCM 620, the AP MLD 600 may receive the ICF 630 on Link 1 603 and transmit an ICR 640 on Link 1 603 in response to the ICF 630. When transmitting the ICR 640, the AP MLD 600 may set a duration on Link 1 603, for receiving the data corresponding to the ICF 630 transmitted by the terminal. In an embodiment, the duration set on Link 1 603 may be determined in consideration of a time when the AP MLD 600 will receive the data or a time when the AP MLD 600 will transmit the Ack frame after the data transmission.

The AP MLD 600 may determine whether to dynamically switch the PS mode and the link based on the received ICF 630. In an embodiment, the ICR 640 may include a DPSM switch response element.

In an embodiment, when the AP MLD 600 determines to switch the PS mode and the link based on the ICF 630, it may switch from the doze state 623 to the HCM 625 on Link 2 605 after transmitting the ICR 640. In another embodiment, when the AP MLD 600 determines to switch the PS mode based on the ICF 630, it may switch from the doze state 623 to the HCM 625 on Link 2 605 after receiving the ICF 630.

Thereafter, the non-AP MLD 610 may transmit a PPDU 670 on Link 2 605 based on the ICR 640. In an embodiment, the non-AP MLD 610 may transmit the PPDU 670 on Link 2 605 in response to the HCM. In an embodiment, before transmitting the PPDU 670 on Link 2 605 based on the ICR 640, the non-AP MLD 610 may transmit a CF-End frame 650 on Link 1 603 to terminate the previously designated duration 635 on Link 1 603. In an embodiment, an actual duration 655 secured by the ICF 630 may be shorter than the previously designated duration 635 due to the CF-End frame 650. In an embodiment, the non-AP MLD 610 may transmit the PPDU 670 with BW=80 MHz and SS=2 on Link 2 605.

In an embodiment, in the HCM 625, the AP MLD 600 may receive the PPDU 670 on Link 2 605 and transmit a BA frame 675 on Link 2 605 in response to the PPDU 670. In an embodiment, the AP MLD 600 may transmit a CF-End frame 660 in response to the CF-End frame 650 to terminate the duration set on Link 1 603 by the ICR 640.

That is, even if the AP MLD 600 sets the duration on Link 1 603 in consideration of the time when it will transmit the Ack frame after the data transmission, when it receives the CF-End frame 650 on Link 1 603, it may transmit the CF-End frame 660 to early terminate the duration set on Link 1 603 by the ICR 640. In an embodiment, due to the early termination, an actual duration 665 secured by the ICR 640 may be shorter than the duration on Link 1 603 set by the ICR 640.

The AP MLD 600 may switch from the HCM 625 to the doze state 627 on Link 2 605, after transmitting the BA frame 675.

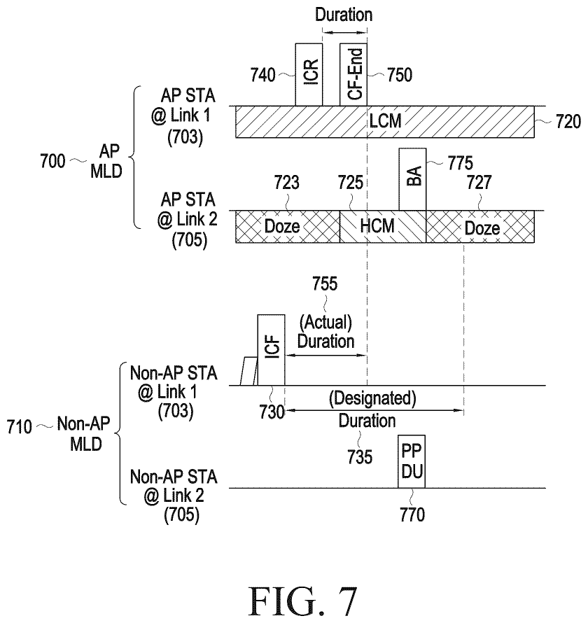

FIG. 7 illustrates an operation of terminating a set duration using a “CF-End” frame in a cross-link DPS operation in an MLO environment by an AP according to an embodiment of the disclosure.

An AP MLD 700 and a non-AP MLD 710 illustrated in FIG. 7 may be connected and communicate with each other, similar to the AP 140, the electronic device 100, and the STA 150 described in FIGS. 1A and 1B. The non-AP MLD 710 illustrated in FIG. 7 may be an STA included in the BSS of the AP MLD 710 as described with reference to FIG. 2.

The AP MLD 700 and the non-AP MLD 710 illustrated in FIG. 7, which are MLDs, that is, devices capable of performing an MLO, may operate in different bands, namely Link 1 703 and Link 2 705. In an embodiment, Link 2 705 may be a higher band than Link 1 703 and use a channel with a wider BW than Link 1 703. For example, Link 1 703 and Link 2 705 may include, but are not limited to, 2.4 GHz and 5 GHz, respectively.

The AP MLD 700 and the non-AP MLD 710 illustrated in FIG. 7, which are MLDs, that is, devices capable of performing an MLO, may operate in different bands, namely Link 1 703 and Link 2 705. In an embodiment, Link 2 705 may be a higher band than Link 1 703 and use a channel with a wider BW than Link 1 703. For example, Link 1 703 and Link 2 705 may include, but are not limited to, 2.4 GHz and 5 GHz, respectively.

Referring to FIG. 7, when operating in the DPS mode, the AP MLD 700 operates in doze states 723 and 727 and an active state. In the active state, it may operate by setting an LCM 720 and an HCM 725.

The operation of FIG. 7 differs from the operation of FIG. 6 in that an AP MLD 700 first transmits a CF-END frame 750 on Link 1 703 to early terminate a duration set by an ICR 740 from the AP MLD 700 on Link 1 703 and a duration 735 set by an ICF 730 from a non-AP MLD 710 on Link 1 703. Therefore, the operations and components 730, 735, 740, 755, and 770 illustrated in FIG. 7, excluding the transmission of the CF-END frame 750 from the AP MLD 700, correspond to the operations and components 630, 635, 640, 655, and 670 illustrated in FIG. 6 excluding the transmission of the CF-End frame 650 from the non-AP MLD 610 and the transmission of the CF-END frame 660 from the AP MLD 600.

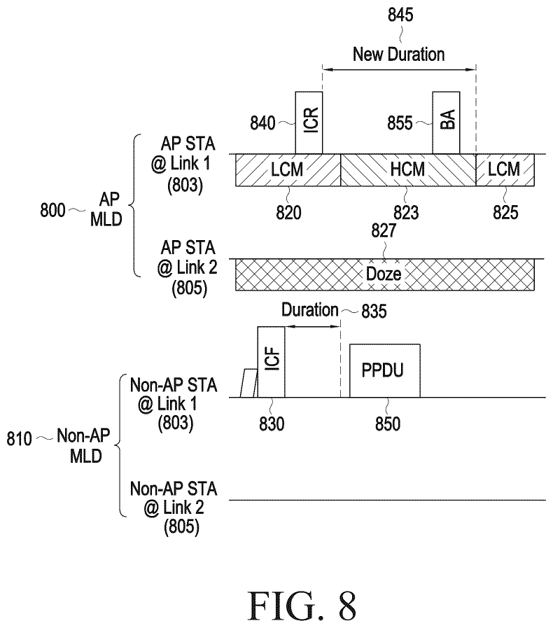

FIG. 8 illustrates an operation of setting a new duration in a non-cross-link DPS operation in an MLO environment by an AP according to an embodiment of the disclosure.

An AP MLD 800 and a non-AP MLD 810 illustrated in FIG. 8 may be connected and communicate with each other, similar to the AP 140, the electronic device 100, and the STA 150 described in FIGS. 1A and 1B. The non-AP MLD 810 illustrated in FIG. 8 may be an STA included in the BSS of the AP MLD 810 as described with reference to FIG. 2.

The AP MLD 800 and non-AP MLD 810 illustrated in FIG. 8, which are MLDs, that is, devices capable of performing an MLO, may operate in different bands, namely Link 1 803 and Link 2 805. In an embodiment, Link 2 805 may be a higher band than Link 1 803 and use a channel with a wider BW than Link 1 803. For example, Link 1 803 and Link 2 805 may include, but are not limited to, 2.4 GHz and 5 GHZ, respectively.

Referring to FIG. 8, when operating in the DPS mode, the AP MLD 800 operates in a doze state 827 and an active state. In the active state, it may operate by setting LCMs 820 and 825 and an HCM 823.

Referring to FIG. 8, when the non-AP MLD 810 intends to transmit or receive, it may participate in contention and transmit an ICF 830 on Link 1 803. When the non-AP MLD 810 transmits the ICF 830, it may initiate a frame exchange sequence and set a duration 835, which is a time interval during which it has the right to restrict transmissions from other APs or STAs. In an embodiment, the non-AP MLD 810 may set the duration 835 in consideration of a time when it will receive an ICR transmitted in response to the ICF 830. In an embodiment, the duration 835 may be shorter than a time from transmission of data in the frame exchange sequence initiated by the ICF 830 until reception of an Ack frame for the data. In an embodiment, the ICF 830 may include a DPSM switch request element.

The AP MLD 800 may operate in the LCM 820 on Link 1 803 and in the doze state 827 on Link 2 805. In the LCM 820, the AP MLD 800 may receive the ICF 830 on Link 1 803 and transmit an ICR 840 on Link 1 803 in response to the ICF 830. The AP MLD 800 may determine whether to dynamically switch the PS mode and the link based on the received ICF 830.

In an embodiment, when the AP MLD 800 determines to switch the PS mode but not the link based on the ICF 830, it may set a duration 845 on Link 1 803, for receiving data corresponding to the ICF 830 transmitted by the terminal, when transmitting the ICR 840. In an embodiment, the duration 845 may be determined in consideration of a time when the AP MLD 800 will receive the data or a time when it will transmit an Ack frame after the data transmission. In an embodiment, the ICR 840 may include a DPSM switch response element.

In an embodiment, when the AP MLD 800 determines to switch the PS mode based on the ICF 830, it may switch from the LCM 820 to the HCM 823 on Link 1 803 after transmitting the ICR 840. In an embodiment, when the AP MLD 800 determines to switch the PS mode based on the ICF 830, it may switch from the LCM 820 to the HCM 823 on Link 1 803 after receiving the ICF 830.

Thereafter, the non-AP MLD 810 may transmit a PPDU 850 on Link 1 803 based on the ICR 840. In an embodiment, the non-AP MLD 810 may transmit the PPDU 850 on Link 1 803 in response to the HCM based on the ICR 840.

In the HCM 823, the AP MLD 800 may receive the PPDU 850 on Link 1 803 and transmit a BA frame 855 on Link 1 803 in response to the PPDU 850. Thereafter, the AP MLD 800 may switch to the LCM on Link 1 803.

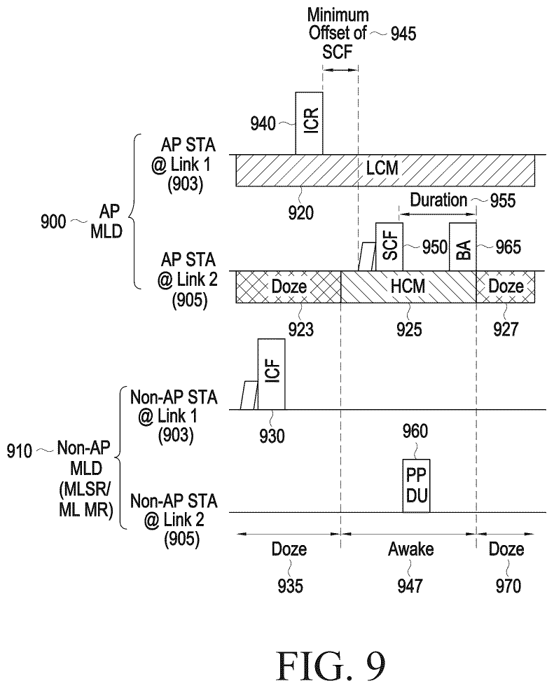

FIG. 9 illustrates an operation of securing a duration using a control frame in a cross-link DPS operation in an MLO environment by an AP according to an embodiment of the disclosure.

An AP MLD 900 and a non-AP MLD 910 illustrated in FIG. 9 may be connected and communicate with each other, similar to the AP 140, the electronic device 100, and the STA 150 described in FIGS. 1A and 1B. The non-AP MLD 910 illustrated in FIG. 9 may be an STA included in the BSS of the AP MLD 910 as described with reference to FIG. 2.

The AP MLD 900 and the non-AP MLD 910 illustrated in FIG. 9, which are MLDs, that is, devices capable of performing an MLO, may operate in different bands, namely Link 1 903 and Link 2 905. In an embodiment, Link 2 905 may be a higher band than Link 1 903 and use a channel with a wider BW than Link 1 903. For example, Link 1 903 and Link 2 905 may include, but are not limited to, 2.4 GHz and 5 GHz, respectively.

In an embodiment, the non-AP MLD 910 may be either an MLMR-supporting terminal or an MLSR-supporting terminal. As described above, when the non-AP MLD 910 is an MLMR-supporting terminal, it may use Link 1 903 and Link 2 905 simultaneously and monitor both Link 1 903 and Link 2 905. When the non-AP MLD 910 is an MLSR-supporting terminal, it is not capable of using Link 1 903 and Link 2 905 simultaneously, and may switch from Link 1 903 to Link 2 905. When using Link 1 903, the non-AP MLD 910 is not monitoring the channel state of Link 2 905, and thus when switching links, a time for channel synchronization may be required.

Referring to FIG. 9, when operating in the DPS mode, the AP MLD 900 operates in doze states 923 and 927 and an active state. In the active state, it may operate by setting an LCM 920 and an HCM 925.

Referring to FIG. 9, when the non-AP MLD 910 intends to transmit or receive, it may participate in contention and transmit an ICF 930 on Link 1 903. When the non-AP MLD 910 transmits the ICF 930, it may set a duration on Link 1 903. For example, when transmitting the ICF 930, the non-AP MLD 910 may set the duration by applying the duration setting methods described in FIGS. 5, 6, and 7.

In an embodiment, the ICF 930 may include a DPSM switch request element. The DPSM switch request element may include non-AP request information required for performing a cross-link DPSM operation.

The AP MLD 900 may operate in the LCM 920 on Link 1 903 and in the doze state 923 on Link 2 905. In the LCM 920, the AP MLD 900 may receive the ICF 930 on Link 1 903 and transmit an ICR 940 on Link 1 903 in response to the ICF 930. The AP MLD 900 may determine whether to dynamically switch the PS mode and the link based on the received ICF 930.

In an embodiment, when the AP MLD 900 determines to switch the PS mode and the link based on the ICF 930, the AP MLD 900 may not secure, on Link 1 903, a duration for receiving data corresponding to the ICF 930 transmitted by the terminal, when transmitting the ICR 940.

In an embodiment, the ICR 940 may include a DPSM switch response element. In an embodiment, the DPSM switch response element may include response information of the AP MLD 900 to the DPSM switch request element.

In an embodiment, when the AP MLD 900 determines to switch the PS mode and the link based on the ICF 930, it may switch from the doze state 923 to the HCM 925 on Link 2 905 after transmitting the ICR 940. In another embodiment, when the AP MLD 900 determines to switch the PS mode based on the ICF 930, it may switch from the doze state 923 to the HCM 925 on Link 2 905 after receiving the ICF 930.

Thereafter, the AP MLD 900 may transmit a second control frame (SCF) 950 in a contention situation to secure a duration 955 on Link 2 905. The SCF 950 may be transmitted on Link 2 905 to protect a duration for data transmission from the non-AP MLD 910.

Thereafter, the non-AP MLD 910 may transmit a PPDU 960 on Link 2 905 based on the ICR 940. In an embodiment, the non-AP MLD 910 may transmit the PPDU 960 on Link 2 905 in response to the HCM. In an embodiment, after receiving the ICR 940 on Link 1 903, the non-AP MLD 910 may switch from a doze state 935 to an awake state 947 to transmit the PPDU 960 on Link 2 905.

In an embodiment, the DPSM switch response element included in the ICR 940 may include information about a minimum offset 945 of the SCF 950. In an embodiment, the non-AP MLD 910 may identify a time when the SCF 950 will be received, based on the information about the minimum offset 945. In an embodiment, when the non-AP MLD 910 is an MLSR-supporting terminal, it may perform a synchronization operation based on the SCF 950 after switching from the doze state 935 to the awake state 947. The length of the minimum offset 945 may be determined in consideration of the capabilities of the terminal.

In the HCM 925, the AP MLD 900 may receive the PPDU 960 on Link 2 905 and transmit a BA frame 965 on Link 2 905 in response to the PPDU 960. Thereafter, the AP MLD 900 and the non-AP MLD 910 may switch to doze states 927 and 970, respectively on Link 2 905.

In the present disclosure, the terms “field” and “subfield” are used interchangeably, regardless of whether the information unit is composed of a single octet or multiple bits. Accordingly, even if a specific component is described as a “field” or a “subfield” in the present disclosure, it may be technically interpreted as being interchangeable with the other.

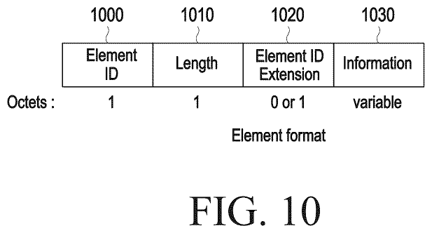

FIG. 10 illustrates the structure of a management frame format according to an embodiment of the disclosure.

More specifically, FIG. 10 illustrates an element format of a management frame in an IEEE 802.11 system applicable to the disclosure.

Referring to FIG. 10, the management frame in the IEEE 802.11 system may include at least one of Element identifier (ID) field 1000, Length 1010, Element ID Extension field 1020, or Information 1030.

An element included in the management frame may be indicated by predefined values included in the Element ID field 1000 and the Element ID Extension field 1020. In an embodiment, when the value of the Element ID field 1000 is ‘255’, the value of the Element ID Extension field 1020 may be extended to indicate the element included in the management frame. A field included in the Information 1030 may be variably determined according to values included in the Element ID field 1000 and the Element ID Extension field 1020.

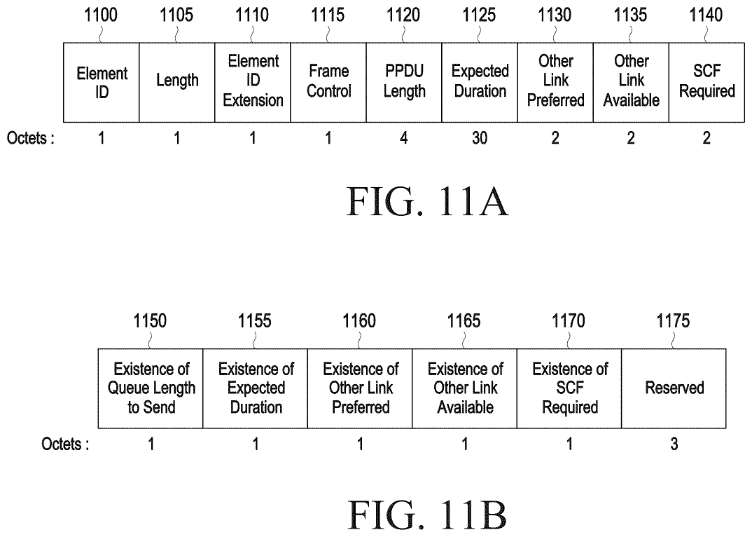

FIGS. 11A and 11B illustrate a format of a DPSM switch request element according to various embodiments of the disclosure.

Referring to FIG. 11A, the format of the DPSM switch request element of a management frame may include at least one field of Element ID field 1100, Length field 1105, Element ID Extension field 1110, Frame Control field 1115, PPDU length field 1120, Expected Duration 1150, Other Link Preferred field 1130, Other Link Available field 1135, or SCF Required field 1140.

In an embodiment, a non-AP STA may transmit, to an AP STA, information in the DPSM switch request element format illustrated in FIG. 11A through an ICF.

In an embodiment, in the format of the DPSM switch request element, the Element ID field 1100 may include a value of ‘255’. In an embodiment, in the format of the DPSM switch request element, the Element ID Extension field 1110 may include, for example, a value of ‘111’ to indicate that a corresponding frame includes information related to the DPSM switch request element.

In an embodiment, the Length field 1105 (e.g., 1 byte) may include a value indicating the length (in bytes) of the DPSM switch request element.

In an embodiment, the Frame Control field 1115 (e.g., 1 byte) may include sub-elements illustrated in FIG. 11B and indicate whether there are elements corresponding to the sub-elements in the format of the DPSM switch request element.

Referring to FIG. 11B, the Frame Control field 1115 may include at least one subfield of Existence of Queue Length to Send 1150, Existence of Expected Duration 1155, Existence of Other Link Preferred 1160, Existence of Other Link Available 1165, Existence of SCF Required 1170, or Reserved subfield 1175. Each subfield included in the Frame Control field 1115 may include a 1-bit value, except for the 3-bit Reserved subfield 1175.

In an embodiment, the PPDU length field 1120 (e.g., 4 bytes) may include a value indicating the length (in bytes) of a PPDU and be used to calculate a required transmission duration.

In an embodiment, the Expected Duration field 1125 (e.g., 30 bytes) may include a value indicating the length of an expected (or required) duration for the PPDU transmission. In an embodiment, the Expected Duration field 1125 may include a value (e.g., in 2 bytes) indicating the length (in usec) of an expected duration for each link ID (e.g., 0 to 14).

In an embodiment, the Other Link Preferred field 1130 (e.g., 2 bytes) may include a value indicating whether the non-AP STA requests PPDU transmissions for other link IDs (e.g., 0 to14).

In an embodiment, the Other Link Available field 1135 (e.g., 2 bytes) may include a value indicating whether the non-AP STA does not request PPDU transmissions for other link IDs (e.g., 0 to 14) but those links are available for PPDU transmissions.

In an embodiment, the SCF Required field 1140 (e.g., 2 bytes) may include a value indicating whether the non-AP STA needs to receive an SCF for other link IDs (e.g., 0 to 14).

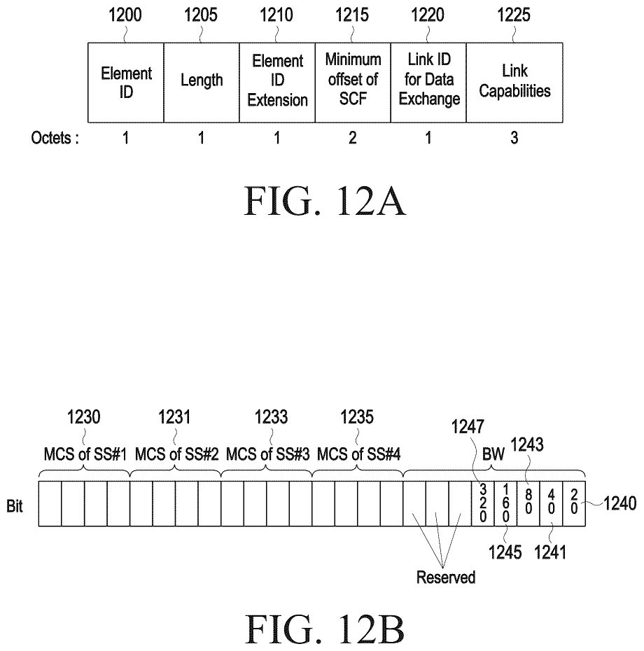

FIG. 12A illustrates a format of a DPSM switch response element according to an embodiment of the disclosure.

Referring to FIG. 12A, the format of the DPSM switch response element of a management frame may include at least one field of Element ID field 1200, Length field 1205, Element ID Extension field 1210, Minimum offset of SCF field 1215, Link ID for Data Exchange field 1220, or Link Capabilities field 1225.

In an embodiment, an AP may determine a link for data exchange with a non-AP STA in an HCM and transmit information, to the non-AP STA, in the DPSM switch response element format illustrated in FIG. 12A through an ICR.

In an embodiment, in the format of the DPSM switch response element, the Element ID field 1200 may include a value of ‘255’. In an embodiment, in the format of the DPSM switch response element, the Element ID Extension field 1210 may include, for example, a value of ‘111’ (or another value) to indicate that a corresponding frame includes information related to the DPSM switch response element.

In an embodiment, the Length field 1205 (e.g., 1 byte) may include a value indicating the length (e.g., in bytes) of the DPSM switch response element.

In an embodiment, the Minimum offset of SCF field 1215 (e.g., 2 bytes) may include information about a minimum offset time from the transmission of the ICR until the transmission of the SCF, when transmitting the SCF.

In an embodiment, the Link ID for Data Exchange field 1220 (e.g., 1 byte) may include a value indicating a link for data exchange. In an embodiment, the value indicating the link may include one of link IDs (e.g., 0 to 14). In an embodiment, the Link ID for Data Exchange field 1220 may use 1 byte, and for example, when 15 link IDs from 0 to 14 are used, 15 to 255 may be reserved.

The Link Capabilities field 1225 (e.g., 3 bytes) may include MCS information and BW information for the link for data exchange. In an embodiment, the MCS information may indicate MCS values of 0 to 15 and 4 spatial streams by 2-byte values. In an embodiment, the BW information may indicate one of 20 MHz, 40 MHZ, 80 MHz, 160 MHz, and 320 MHz by a 1-byte value.

FIG. 12B is a diagram illustrating subfields of the Link Capabilities field included in the DPSM switch response element format according to an embodiment of the disclosure.

FIG. 12B is a diagram illustrating bits included in Link Capabilities field 1225 (e.g., 3 bytes).

In an embodiment, 2 bytes (i.e., 16 bits) included in the Link Capabilities field 1225 may include 4 bits of information 1230, 1231, 1233, and 1235 indicating MCS information of 0 to 15 for each of 4 spatial streams. For example, the Link Capabilities field 1225 may indicate MCS information of 0 to 16 for SS #1 by the 4-bit information 1230.

In an embodiment, 1 byte (i.e., 8 bits) included in the Link Capabilities field 1225 may indicate one of the BWs of 20 MHz 1240, 40 MHz 1241, 80 MHz 1243, 160 MHz 1245, and 320 MHz 1247.

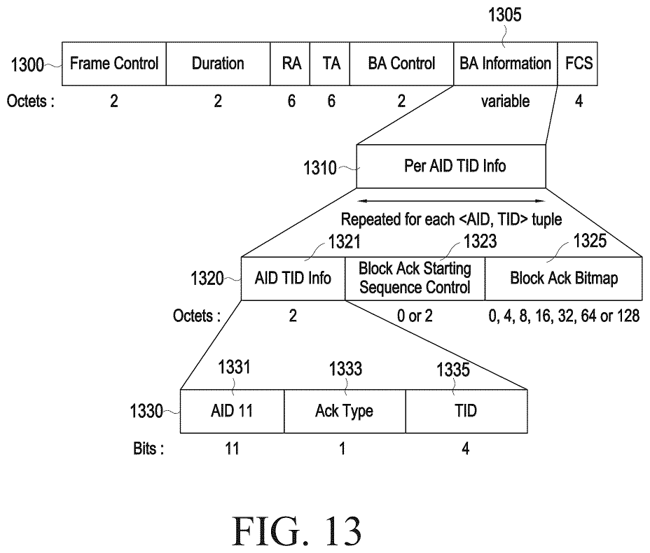

FIG. 13 illustrates the structure of a Multi-STA BlockAck frame format according to an embodiment of the disclosure.

More specifically, FIG. 13 illustrates a field format of Multi-STA BlockAck among control frames in an IEEE 802.11 system applicable to the disclosure.

Referring to FIG. 13, a BlockAck frame format 1300 may include a BA information field 1305. Like a BA information field format, the BA information field 1305 may include at least one Per association ID (AID) traffic ID (TID) Info 1310. The Per AID TID Info 1310 may be repeatedly included for each <AID, TID> tuple.

For each <AID, TID> tuple, the Per AID TID Info 1310 may include at least one subfield of AID TID Info 1321, Block Ack Starting sequence Control 1323, or Block Ack Bitmap 1325, as in a Per AID TID Info subfield format 1320. The AID TID Info 1321 may include at least one subfield of AID 11 1331, Ack Type 1333, or TID 1335, as in an AID TID Info subfield format 1330. For example, when the value of the AID 11 subfield 1331 in the AID TID Info subfield 1321 is not ‘2045’, the Per AID TID Info 1310 may include at least one subfield of AID TID Info 1321, Block Ack Starting sequence Control 1323, or Block Ack Bitmap 1325, for each <AID, TID> tuple, as in a Per AID TID Info subfield format 1320.

In FIG. 13, when the AID 11 subfield 1331 is specified as a control extension of a specific AID, it may represent new control information combined with the Ack Type subfield 1333 and the TID subfield 1335. For example, the AID11 subfield 1331 may be pre-assigned to ‘I’ to ‘2006’, or reserved values ‘2008’ to ‘2042’ may be reused. For example, in this case, reserved Ack Type 1333 and TID 1335 subfields (i.e., setting the Ack Type subfield to ‘O’ or ‘l’ and the TID subfield to values ‘8’ to ‘13’) may be used to indicate new control information.

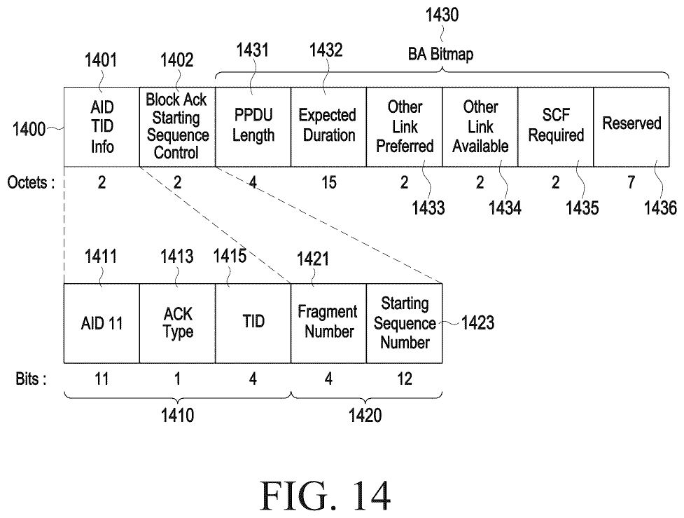

FIG. 14 illustrates an example of a DPSM switch request element format included in a Multi-STA BlockAck frame format according to an embodiment of the disclosure.

FIG. 14 illustrates a Per AID TID Info subfield format 1400 included in the BA information field of the Multi-STA BlockAck frame format.

In an embodiment, the non-AP STA may transmit information in the DPSM switch request element format illustrated in FIG. 14 through an ICF using the Multi-STA BlockAck frame format to the AP STA.

The DPSM switch request element format included in the Per AID TID

Info subfield format 1400 may include the subfields of AID TID Info subfield 1401, Block Ack Starting Sequence Control 1402, and Block Ack Bitmap subfield 1430.

In an embodiment, the AID TID Info subfield 1401 (e.g., 2 bytes) subfield may include at least one subfield of AID 11 1411, Ack Type 1413, or TID 1415, as in an AID TID Info subfield format 1410.

In an embodiment, a value included in at least one subfield of AID 11 1411, Ack Type 1413, or TID 1415 may indicate that a corresponding frame includes the DPSM switch request element format. For example, the AID 11 subfield 1411 may include the AID of a corresponding non-AP STA or a specific value (e.g., ‘2008’ to ‘2044’). For example, a pair of values [Ack Type, TID] in the Ack Type 1413 and TID 1415 subfields may include [‘0’ or ‘1’, ‘8’ to ‘13’], or [‘1’, ‘14’], or [‘0’, ‘15’].

The Block Ack Starting Sequence Control subfield 1403 (e.g., 2 bytes) may include at least one subfield of Fragment Number subfield 1421 or Starting Sequence Number subfield 1423, as in a Block Ack Starting Sequence Control subfield format 1420. In an embodiment, the Fragment Number subfield 1421 (e.g., 4 bits) may be set to a value indicating the length (e.g., 32 bytes, 64 bytes, or 128 bytes) of the Block Ack Bitmap subfield 1430. In an embodiment, the Starting Sequence Number subfield 1423 (e.g., 12 bits) may indicate a multiple value of an expected duration. That is, the value included in the Starting Sequence Number subfield 1423 may be multiplied by the value of an Expected Duration subfield 1432 to be described later and used to indicate the length (e.g., in usec by 2 bytes) of the expected duration for each link ID (e.g., 0 to 14).

In an embodiment, the Starting Sequence Number subfield 1423 (e.g., 12 bits) may be set to a reserved value. In this case, the Block Ack Bitmap subfield 1430 may be 64 bytes, and the Expected Duration subfield 1432 to be described later may be 30 bytes, so that the value of the Expected Duration subfield 1432 may be used to indicate the length (e.g., in usec) of the expected duration for each link ID (e.g., 0 to 14) (e.g. by 2 bytes).

The Block Ack Bitmap subfield 1430 (e.g., 32 bytes) may include at least one subfield of PPDU length 1431, Expected Duration subfield 1432, Other Link Preferred 1433, Other Link Available 1434, SCF Required 1435, or reserved 1436, and the description of the subfields in FIG. 11B may be applied equally to the same subfields.

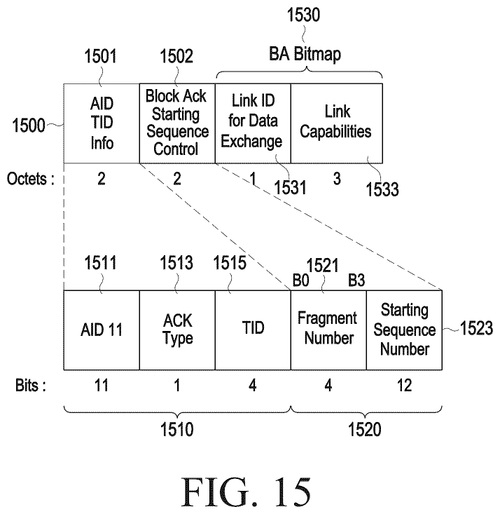

FIG. 15 illustrates an example of a DPSM switch response element format included in a Multi-STA BlockAck frame format according to an embodiment of the disclosure.

FIG. 15 illustrates a Per AID TID Info subfield format 1500 included in a BA information field of a Multi-STA BlockAck frame.

In an embodiment, an AP may determine a link for data exchange in an HCM with a non-AP STA and transmit information in the DPSM switch response element format through an ICR using the Multi-STA BlockAck frame format.

The DPSM switch response element format included in the Per AID TID Info subfield format 1500 may include the subfields of AID TID Info subfield 1501, Block Ack Starting Sequence Control subfield 1502, and Block Ack Bitmap subfield 1530.

In an embodiment, the AID TID Info subfield 1501 (e.g., 2 bytes) may include at least one subfield of AID 11 1511, Ack Type 1513, or TID 1515.

In an embodiment, a value included in at least one subfield of AID 11 1511, Ack Type 1513, or TID 1515 may indicate that a corresponding frame includes the DPSM switch response element format. For example, the AID 11 subfield 1511 may include the AID of the non-AP STA or a specific value (e.g., ‘2008’ to ‘2044’). For example, a pair of values [Ack Type, TID] of the Ack Type subfield 1513 and the TID 1515 may be [‘0’ or ‘1’, ‘8’ to ‘13’], or [′1′, ‘14’], or [′0′, ‘15’].

The Block Ack Starting Sequence Control subfield 1502 (e.g., 2 bytes) may include at least one subfield of Fragment Number subfield 1521 or Starting Sequence Number subfield 1523. In an embodiment, the Fragment Number subfield 1521 (e.g., 4 bits) may be set to a value indicating the length (e.g., 32 bytes, 64 bytes, or 128 bytes) of the Block Ack Bitmap subfield 1530. For example, when the value of the Fragment Number subfield 1521 (e.g., 4 bits) is ‘0110’ (B3-B0), this may indicate that the length of the Block Ack Bitmap subfield 1530 is 4 bytes. In an embodiment, when an SCF is transmitted, a Starting Sequence Number subfield 1523 (e.g., 12 bits) may include information about a minimum offset time from transmission of an ICR until the transmission of the SCF.

The Block Ack Bitmap subfield 1530 (e.g., 4 bytes) may include at least one field of Link ID for Data Exchange 1531 or Link Capabilities 1553, and the description of the subfields in FIG. 12A may be applied equally to the same subfields.

The size and position of each field included in the frame formats or element formats illustrated in FIGS. 10, 11A, 11B, 12A, 12B, and 13 to 15 are an example for convenience and may have various values according to design specifications.

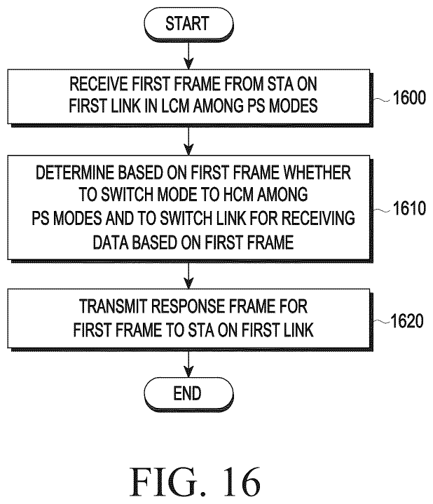

FIG. 16 is a flowchart illustrating an operation of an AP according to an embodiment of the disclosure.

In operation 1600, the AP may receive a first frame from an STA on a first link in an LCM among PS modes.

In operation 1610, based on the first frame, the AP may determine whether to switch to an HCM among the PS modes and whether to switch a link for receiving data based on the first frame.

In operation 1620, the AP may transmit a response frame for the first frame to the STA on the first link.

In an embodiment, when the AP determines to switch the PS mode to the HCM and the link for receiving the data to a second link, the response frame may include information indicating that the data will be transmitted on the second link.

In an embodiment, the AP may switch the PS mode on the second link to the HCM and receive the data based on the first frame from the STA on the second link. In an embodiment, the data may be received in response to the HCM among the PS modes.

In an embodiment, a duration based on the first frame may be set on the first link in consideration of a time when the response frame will be received. In an embodiment, the duration may correspond to a time interval during which the STA initiates a frame exchange sequence by the first frame and has the right to use a channel.

When it is determined to switch the PS mode to the HCM and the link for receiving the data to the second link, a duration based on the response frame for the first frame may not be set on the first link.

In an embodiment, the duration may correspond to a time interval during which the AP has the right to use the channel during the frame exchange sequence based on the first frame.

In an embodiment, the first frame may include DPSM switch request information. In an embodiment, the DPSM switch request information may include at least one of information about a length of the data, information about an expected duration based on the first frame, information about a requested link for transmitting the data based on the first frame, information about an available link for transmitting the data based on the first frame, or information requesting transmission of a second frame for setting the duration of the data.

In an embodiment, the response frame may include DPSM switch response information. In an embodiment, the DPSM response information may include at least one of information about a minimum offset of an SCF, an ID of a link for data exchange, or capability information about the link for the data exchange, to set the duration of the data to be transmitted on the second link.

In an embodiment, the first frame and the response frame may include one of a management frame and a Multi-STA BlockAck frame.

In an embodiment, the AP may set a duration based on the response frame for the first frame on the first link. In an embodiment, the duration may correspond to a time interval during which the AP has the right to use the channel during the frame exchange sequence initiated by the first frame. In an embodiment, the AP may receive a CF-End frame from the STA on the first link and terminate the duration in response to the CF-End frame.

In an embodiment, the AP may set a duration based on the response frame for the first frame on the first link. In an embodiment, the duration may correspond to a time interval during which the AP has the right to use the channel during the frame exchange sequence initiated by the first frame. In an embodiment, when the AP determines to switch the PS mode to the HCM and the link for receiving the data based on the first frame to the second link, the AP may transmit a CF-End frame on the first link. In an embodiment, the AP may terminate the duration based on the CF-End frame.

In an embodiment, when the AP determines to switch the PS mode to the HCM and not to switch the link for receiving the control frame, the AP may set a second duration based on the response frame for the first frame on the first link. In an embodiment, the second duration may be set based on a time when the AP will transmit a BA frame for the data.

In an embodiment, when the AP determines to switch the PS mode to the HCM and the link for receiving the data to the second link, the AP may transmit the second frame on the second link, for setting the duration of the data to be received on the second link.

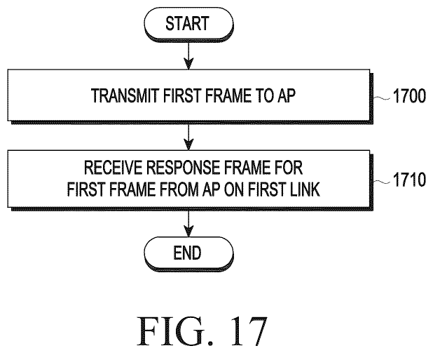

FIG. 17 is a flowchart illustrating an operation of an STA according to an embodiment of the disclosure.

In operation 1700, the STA may transmit a first frame to an AP.

In operation 1710, the STA may receive a response frame for the first frame from the AP on the first link.

In an embodiment, when it is determined to switch a PS mode of the AP to an HCM and to switch a link for receiving data based on the first frame to a second link, the response frame may include information indicating that the data will be transmitted on the second link.

In an embodiment, the STA may transmit the data based on the first frame to the AP on the second link, in response to the HCM.

The STA may set a duration based on the first frame on the first link, in consideration of a time when the response frame will be received. The duration may correspond to a time interval during which the STA initiates a frame exchange sequence by the first frame and has the right to use a channel.

In an embodiment, when it is determined to switch the PS mode of the AP to the HCM and to switch the link for receiving the data based on the first frame to the second link, a duration based on the response frame for the first frame may not be set on the first link. In an embodiment, the duration may correspond to a time interval during which the AP has the right to use the channel during the frame exchange sequence initiated by the first frame.

In an embodiment, the first frame may include DPSM switch request information. In an embodiment, the response frame may include DPSM switch response information. In an embodiment, the DPSM switch response information may include at least one of information about a length of the data, information about an expected duration based on the first frame, information about a requested link for transmitting the data based on the first frame, information about an available link for transmitting the data based on the first frame, or information requesting transmission of a second frame, for setting a duration for the data to be transmitted on the second link.

In an embodiment, the response frame may include DPSM switch response information. In an embodiment, the DPSM switch response information may include at least one of information about a minimum offset of a second frame for setting a duration for the data to be transmitted on the second link, an ID of a link for data exchange, or capability information about the link for the data exchange.

In an embodiment, the first frame and the response frame may include one of a management frame and a Multi-STA BlockAck frame.

In an embodiment, the STA may set the duration based on the first frame on the first link. In an embodiment, the duration may correspond to a time interval during which the STA has the right to use the channel during the frame exchange sequence initiated by the first frame.

In an embodiment, when it is determined to switch the PS mode to the HCM and to switch the link for receiving the data to the second link, the STA may transmit a CF-End frame to the AP on the first link and terminate the duration.

In an embodiment, the STA may set the duration based on the first frame on the first link. In an embodiment, the duration may correspond to a time interval during which the STA has the right to use the channel during the frame exchange sequence initiated by the first frame.

In an embodiment, the STA may receive a CF-End frame from the AP on the first link. In an embodiment, the STA may terminate the duration based on the CF-End frame.

In an embodiment, when it is determined to switch the PS mode to the HCM and not to switch the link for receiving the control frame, a second duration based on the response frame for the first frame may be set on the first link. In an embodiment, the second duration may be set based on a time when a BA frame for the data will be transmitted.

In an embodiment, the STA may receive, on the second link, a second frame for setting a duration for the data to be received on the second link.

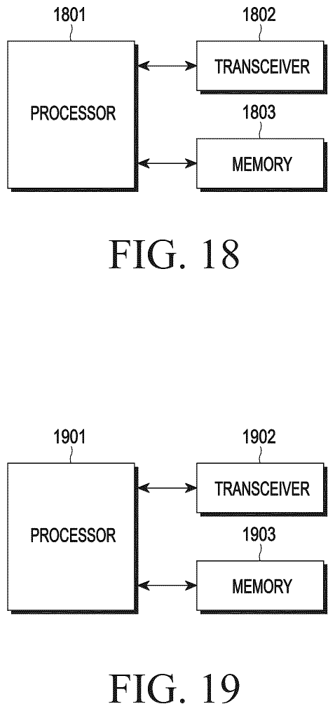

FIG. 18 is a diagram illustrating a configuration of an AP according to an embodiment of the disclosure.

Referring to FIG. 18, the AP may include a processor 1801, a transceiver 1802, and memory 1803. The processor 1801, the transceiver 1802, and the memory 1803 of the AP may operate according to the method(s) described in the embodiments described before with reference to FIGS. 1A, 1B, 2, 3A, 3B, 4 to 10, 11A, 11B, 12A, 12B, and 13 to 17. However, the components of the AP are not limited to the above example. For example, the AP may include more or fewer components than the above components. In addition, the processor 1801, the transceiver 1802, and the memory 1803 may be implemented in the form of at least one chip.

The transceiver 1802, which collectively refers to a receiver and a transmitter, may transmit and receive signals to and from an STA or another network entity. In this case, the transmitted and received signals may include at least one of control information or data. To this end, the transceiver 1802 may include an RF transmitter that up-converts and amplifies the frequency of a transmitted signal, and an RF receiver that low-noise amplifies and down-converts the frequency of a received signal. This is merely an embodiment of the transceiver 1802, and the components of the transceiver 1802 are not limited to an RF transmitter and an RF receiver. Further, the transceiver 1802 may receive a signal and output the received signal to the processor 1801, and transmit a signal output from the processor 1801 to another network entity through a network.

The memory 1803 may store a program and data required for the operation of the AP according to at least one of the embodiments of FIGS. 1A, 1B, 2, 3A, 3B, 4 to 10, 11A, 11B, 12A, 12B, and 13 to 17. Further, the memory 1803 may store control information and/or data included in a signal obtained at the AP. The memory 1803 may be configured as a storage medium or a combination of storage media, such as read only memory (ROM), random access memory (RAM), hard disk, compact disc read only memory (CD-ROM), and digital versatile disc (DVD).

The processor 1801 may control a series of processes to enable the AP to operate according to at least one of the embodiments of FIGS. 1A, 1B, 2, 3A, 3B, 4 to 10, 11A, 11B, 12A, 12B, and 13 to 17. The processor 1801 may include at least one processor.

FIG. 19 is a diagram illustrating a configuration of an STA according to an embodiment of the disclosure.

Referring to FIG. 19, the STA may include a processor 1901, a transceiver 1902, and memory 1903. The processor 1901, the transceiver 1902, and the memory 1903 of the STA may operate according to the method(s) described in the afore-described embodiments of FIGS. 1A, 1B, 2, 3A, 3B, 4 to 10, 11A, 11B, 12A, 12B, and 13 to 17. However, the components of the STA are not limited to the above example. For example, the STA may include more or fewer components than the above components. Further, the processor 1901, the transceiver 1902, and the memory 1903 may be implemented in the form of at least one chip.

The transceiver 1902, which collectively refers to a receiver and a transmitter, may transmit and receive signals to and from an STA or another network entity. The transmitted and received signals may include at least one of control information or data. To this end, the transceiver 1902 may include an RF transmitter that up-converts and amplifies the frequency of a transmitted signal, and an RF receiver that low-noise amplifies and down-converts the frequency of a received signal. This is merely an embodiment of the transceiver 1902, and the components of the transceiver 1902 are not limited to an RF transmitter and an RF receiver. Further, the transceiver 1902 may receive a signal and output the received signal to the processor 1901, and transmit a signal output from the processor 1901 to another network entity through a network.

The memory 1903 may store a program and data required for the operation of the STA according to at least one of the embodiments of FIGS. 1A, 1B, 2, 3A, 3B, 4 to 10, 11A, 11B, 12A, 12B, and 13 to 17. Further, the memory 1903 may store control information and/or data included in a signal obtained at the STA. The memory 1903 may be configured as a storage medium or a combination of storage media, such as ROM, RAM, hard disk, CD-ROM, and DVD.

The processor 1901 may control a series of processes to enable the STA to operate according to at least one of the embodiments of FIGS. 1A, 1B, 2, 3A, 3B, 4 to 10, 11A, 11B, 12A, 12B, and 13 to 17. The processor 1901 may include at least one processor.

In the specific embodiments of the disclosure described above, the components included in the disclosure are expressed as singular or plural according to the presented specific embodiments. However, the singular or plural expression is merely chosen appropriately for a situation presented for convenience of description. The disclosure is not limited to singular or plural components, and a component expressed in plural may be configured as singular and a component expressed in singular may be configured as plural.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an access point in a wireless local area network (WLAN) system, the method comprising:
receiving, from a station, a first frame on a first link in a lower capability mode (LCM) among power save modes;
determining, based on the first frame, whether to switch to a higher capability mode (HCM) among the power save modes and whether to switch a link for receiving data based on the first frame; and
transmitting, to the station, a response frame for the first frame on the first link,
wherein in case that it is determined to switch the power save mode to the HCM and to switch the link for receiving the data to a second link, the response frame includes information indicating that the data is to be transmitted on the second link.

2. The method of claim 1, further comprising:
switching the power save mode to the HCM on the second link; and
receiving, from the station, the data based on the first frame on the second link,
wherein the data is received corresponding to the HCM among the power save modes.

3. The method of claim 1,
wherein a duration based on the first frame is set on the first link in consideration of a time point at which the response frame is to be received, and
wherein the duration is a time interval during which the station initiates a frame exchange sequence by the first frame and has a right to use a channel.

4. The method of claim 1,
wherein in case that it is determined to switch the power save mode to the HCM and to switch the link for receiving the data to the second link, a duration based on the response frame for the first frame is set to ‘0’ on the first link, and
wherein the duration is a time interval during which the access point has a right to use a channel during a frame exchange sequence initiated by the first frame.

5. The method of claim 1,
wherein the first frame includes dynamic power save mode switch request information, and
wherein the dynamic power save mode switch request information includes at least one of:
information on a length of the data,
information on a predicted duration based on the first frame,
information on a requested link for transmitting the data based on the first frame,
information on an available link for transmitting the data based on the first frame, or
information requesting transmission of a second frame, for setting a duration of the data to be transmitted on the second link.

6. The method of claim 1,
wherein the response frame includes dynamic power save mode switch response information, and
wherein the dynamic power save mode switch response information includes at least one of:
information on a minimum offset of a second frame, for setting a duration of the data to be transmitted on the second link,
an identifier (ID) of a link used for data exchange, or
capability information for the link used for the data exchange.

7. The method of claim 1, wherein the first frame and the response frame include one of a management frame or a Multi-STA BlockAck frame.

8. The method of claim 1, further comprising:
setting a duration based on the response frame for the first frame on the first link, wherein the duration is a time interval during which the access point has a right to use a channel during a frame exchange sequence initiated by the first frame;
receiving a contention free (CF)-End frame from the station on the first link; and
ending the duration in response to the CF-End frame.

9. The method of claim 1, further comprising:
setting a duration based on the response frame for the first frame on the first link, wherein the duration is a time interval during which the access point has a right to use a channel during a frame exchange sequence initiated by the first frame;
in case that it is determined to switch the power save mode to the HCM and to switch the link for receiving the data to the second link, transmitting a CF-End frame on the first link; and
ending the duration based on the CF-End frame.

10. The method of claim 3, further comprising:
in case that it is determined to switch the power save mode to the HCM and not to switch the link for receiving the data, setting a second duration based on the response frame for the first frame on the first link,
wherein the second duration is set in consideration of a time point when a BlockAck (BA) frame for the data is to be transmitted.

11. The method of claim 1, further comprising:
in case that it is determined to switch the power save mode to the HCM and to switch the link for receiving the data to the second link, transmitting, on the second link, a second frame for setting a duration of the data to be received on the second link.

12. The method of claim 1, further comprising:
in case that it is determined to switch the power save mode to the HCM and to switch the link for receiving the data to the second link, transmitting a second frame used to synchronize with the second link by the station on the second link.

13. A method performed by a station in a wireless local area network (WLAN) system, the method comprising:
transmitting, to an access point, a first frame; and
receiving, from the access point, a response frame for the first frame on a first link,
wherein in case that it is determined to switch a power save mode of the access point to a higher capability mode (HCM) and to switch a link for receiving data based on the first frame to a second link, the response frame includes information indicating that the data is to be transmitted on the second link.

14. The method of claim 13, further comprising:
transmitting, to the access point, the data based on the first frame on the second link, corresponding to the HCM among power save modes.

15. The method of claim 13, further comprising:
setting a duration based on the first frame on the first link in consideration of a time point at which the response frame is to be received,
wherein the duration is a time interval during which the station initiates a frame exchange sequence by the first frame and has a right to use a channel.

16. The method of claim 13,
wherein in case that it is determined to switch the power save mode of the access point to the HCM and to switch the link for receiving the data to the second link, a duration based on the response frame for the first frame is set to ‘0’ on the first link, and
wherein the duration is a time interval during which the access point has a right to use a channel during a frame exchange sequence initiated by the first frame.

17. The method of claim 13,
wherein the first frame includes dynamic power save mode switch request information, and
wherein the dynamic power save mode switch request information includes at least one of:
information on a length of the data,
information on a predicted duration based on the first frame,
information on a requested link for transmitting the data based on the first frame,
information on an available link for transmitting the data based on the first frame, or
information requesting transmission of a second frame, for setting a duration of the data to be transmitted on the second link.

18. The method of claim 13, wherein the response frame includes dynamic power save mode switch response information, and
wherein the dynamic power save mode switch response information includes at least one of:
information on a minimum offset of a second frame, for setting a duration of the data to be transmitted on the second link,
an identifier (ID) of a link used for data exchange, or
capability information for the link used for the data exchange.

19. An access point in a wireless local area network (WLAN) system, the access point comprising:
a transceiver;
at least one processor communicatively coupled to the transceiver; and
memory, communicatively coupled to the at least one processor, storing instructions executable by the at least one processor individually or in any combination to cause the access point to:
receive, from a station, a first frame on a first link in a lower capability mode (LCM) among power save modes,
determine, based on the first frame, whether to switch to a higher capability mode (HCM) among the power save modes and whether to switch a link for receiving data based on the first frame, and
transmit, to the station, a response frame for the first frame on the first link,
wherein in case that it is determined to switch the power save mode to the HCM and to switch the link for receiving the data to a second link, the response frame includes information indicating that the data is to be transmitted on the second link.

20. A station in a wireless local area network (WLAN) system, the station comprising:
a transceiver;
at least one processor communicatively coupled to the transceiver; and
memory, communicatively coupled to the at least one processor, storing instructions executable by the at least one processor individually or in any combination to cause the station to:
transmit, to an access point, a first frame, and
receive, from the access point, a response frame for the first frame on a first link,
wherein in case that it is determined to switch a power save mode of the access point to a higher capability mode (HCM) and to switch a link for receiving data based on the first frame to a second link, the response frame includes information indicating that the data is to be transmitted on the second link.
